(19) United States
(12) Patent Application Publication
(10) Pub. No.: US 2026/0197288 A1
(43) Pub. Date: Jul. 9, 2026

(54) TIME-SERIES MESSAGE MANAGEMENT USING DIRECTED PROPERTY GRAPHS

(71) Applicant: Infosys Limited, Bangalore (IN)

(72) Inventors: Chitra THEAGARAJAN, Bengaluru (IN); Steven SCHILDERS, Indianapolis, IN (US)

(73) Assignee: Infosys Limited, Bangalore (IN)

(21) Appl. No.: 19/081,140

(22) Filed: Mar. 17, 2025

(30) Foreign Application Priority Data
Jan. 9, 2025 (IN) 202541001951

(51) Int. Cl. H04L 51/21; G06F 16/2455

(52) U.S. Cl. CPC H04L 51/21; G06F 16/24558

(57) ABSTRACT

A system for time-series message management using directed property graphs is provided. A directed property graph is generated using various messages. The directed property graph comprises various message nodes and attribute nodes, with each message node representing a message, having some attributes of the message associated as node properties thereof, and being associated with attribute nodes that represent shared attributes of the message. To execute a query indicative of time-series computation functions, one or more attribute nodes are identified in the directed property graph. Based on the identified attribute nodes, a set of message nodes is determined. Further, from node properties of each determined message node, one or more message timestamps are identified. Based on the identified message timestamps, the time-series computation functions are executed.

### FIELD OF THE DISCLOSURE

Various embodiments of the present disclosure relate generally to directed property graphs. More specifically, various embodiments of the present disclosure relate to time-series message management using directed property graphs.

### BACKGROUND

In today's interconnected world, nearly every aspect of daily life leverages technology in some form. For example, healthcare systems utilize interconnected technologies to monitor, diagnose, and treat patients in real time. These technology-based ecosystems include various interconnected modules, each responsible for specific functions. For seamless performance, these modules may be required to communicate with minimal latency, as delays in one module's operations can lead to bottlenecks in the overall process. The latency can be minimized by identifying and eliminating sources of idle time or unnecessary delays in communication. Such inefficiencies can be detected by analyzing transactional information associated with messages being communicated between the modules.

Typically, all the messages generated in an ecosystem may be stored in a database (such as a relational database, a non-relational database, a graph database, or the like). The stored messages can be utilized for various use-cases (e.g., real-time analytics) by way of query processing. Efficient retrieval of transactional information associated with the messages from the database may play an important role in query processing. Therefore, the structure of the data storage may directly influence the query performance. That is to say, suboptimal data storage structure can lead to significant inefficiencies, such as increased query latency, higher computational costs, higher storage requirements, or the like. Such delays or inefficiencies can hinder time-sensitive tasks and may negatively affect the overall performance. Ultimately, these drawbacks may degrade the user experience and may increase maintenance overhead.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating time-series message management using directed property graphs are provided substantially as shown in, and described in connection with, at least one of the figures.

In an embodiment of the present disclosure, a system is disclosed. The system includes a storage element and processing circuitry coupled to the storage element. The storage element is configured to store a graph. The graph comprises a plurality of message nodes and a plurality of attribute nodes. Each message node of the plurality of message nodes represents a message. Each message node has a first set of attributes of the message associated as node properties thereof. Further, each message node is associated with a set of attribute nodes, of the plurality of attribute nodes. The set of attribute nodes represents a second set of attributes of the message. The processing circuitry is configured to receive a query. The query is indicative of a set of time-series computation functions to be executed in the graph. The processing circuitry is further configured to identify, based on the query, one or more attribute nodes from the plurality of attribute nodes. Further, the processing circuitry is configured to determine, based on the one or more attribute nodes, a set of message nodes of the plurality of message nodes. The processing circuitry is further configured to identify, from the node properties of each of the set of message nodes, one or more attributes that are required for the execution of the set of time-series computation functions. Each of the one or more attributes corresponds to a message timestamp. Further, the processing circuitry is configured to execute the set of time-series computation functions based on the identified one or more attributes of each of the set of message nodes.

In some embodiments, each message timestamp identified from each message node of the set of message nodes is indicative of a milestone associated with the message represented by the corresponding message node.

In some embodiments, the milestone corresponds to one of a group consisting of a creation event, a raise event, a subscription event, a handle event, or a process event.

In some embodiments, each message timestamp identified from each message node of the set of message nodes corresponds to one of a group consisting of a created-on timestamp, a raised-on timestamp, a received-on timestamp, a handled-on timestamp, or a processed-on timestamp associated with the message represented by the corresponding message node.

In some embodiments, the set of time-series computation functions includes one or more mathematical computations. Upon execution of the one or more mathematical computations on the identified one or more attributes of each of the set of message nodes, a set of computation outputs is generated. The set of computation outputs is indicative of system performance. The processing circuitry is further configured to generate an analytics outcome by executing one or more database operations on the set of computation outputs.

In some embodiments, the one or more database operations comprise at least one of a group consisting of an intersection operation or a union operation.

In some embodiments, each time-series computation function of the set of time-series computation functions includes one or more parameters. The one or more parameter values of the one or more parameters, respectively, are derived from the identified one or more attributes of each of the set of message nodes. The processing circuitry further executes each time-series computation function based on the derived one or more parameter values.

In some embodiments, the processing circuitry is further configured to define the one or more parameters of each time-series computation function of the set of time-series computation functions based on one of a group consisting of one or more message milestones or a user input.

In some embodiments, the message has a plurality of attributes associated therewith. The plurality of attributes comprises at least two of a group consisting of an identifier, a correlation identifier, a user identifier, a name, a category, a topic, a key, a scope, an access, a status, an execution, an action, a message type, a created-on timestamp, a raised-on timestamp, a received-on timestamp, a handled-on timestamp, a processed-on timestamp, a publisher identifier, a subscriber identifier, an allow retry, a maximum retry allowed, a retry count, a retry source identifier, a source identifier, and a source type.

In some embodiments, the first set of attributes comprises at least one of a group consisting of an identifier, a name, a category, a topic, a key, a scope, an access, a status, an execution, an action, a message type, a created-on timestamp, a raised-on timestamp, a received-on timestamp, a handled-on timestamp, a processed-on timestamp, a publisher identifier, a subscriber identifier, an allow retry, a maximum retry allowed, a retry count, a retry source identifier, a source identifier, or a source type.

In some embodiments, each of the second set of attributes is shared with at least one other message.

In some embodiments, the second set of attributes comprises at least one of a group consisting of an identifier, a correlation identifier, a user identifier, a created-on timestamp, a raised-on timestamp, a received-on timestamp, a handled-on timestamp, or a processed-on timestamp.

In some embodiments, for each attribute node of the set of attribute nodes, a third set of attributes is associated as node properties thereof. The third set of attributes is linked with an attribute represented by the corresponding attribute node. The processing circuitry determines the set of message nodes further based on the node properties of each of the one or more attribute nodes.

In some embodiments, at least a first attribute node of the one or more attribute nodes is associated with a first message node and a second message node, of the set of message nodes. The processing circuitry further determines the first message node and the second message node based on the first attribute node.

In some embodiments, the graph further comprises a first plurality of edges, with a set of edges coupling each message node, of the plurality of message nodes, to the corresponding set of attribute nodes. Each edge, of the set of edges, has a set of edge attributes associated as edge properties thereof. The set of edge attributes is indicative of an association between the corresponding message node and a corresponding attribute node. The processing circuitry further determines at least a first message node of the set of message nodes based on at least one of (i) one or more edges, of the first plurality of edges, coupling the one or more attribute nodes to the first message node, respectively, or (ii) the edge properties of each of the one or more edges.

In some embodiments, the edge properties of each edge of the set of edges comprise (i) at least one attribute associated as the node properties of the corresponding message node, and (ii) at least one attribute associated as node properties of the corresponding attribute node.

In some embodiments, the graph further comprises a second plurality of edges, with each edge coupling two message nodes of the plurality of message nodes. Each edge coupling two message nodes has another set of edge attributes associated as edge properties thereof. The other set of edge attributes is indicative of a causal association between the two message nodes. The processing circuitry after determining the first message node of the set of message nodes, is further configured to identify an edge coupling the first message node to a second message node, of the set of message nodes. The processing circuitry further determines the second message node based on the edge properties of the identified edge.

In some embodiments, a second message represented by the second message node is generated based on a processing of a first message represented by the first message node.18

In some embodiments, the graph further comprises a third plurality of edges, with each edge coupling two attribute nodes of the plurality of attribute nodes. Each edge coupling two attribute nodes has another set of edge attributes associated as edge properties thereof. The other set of edge attributes is indicative of an association between the two attribute nodes. The processing circuitry is further configured to identify an edge, of the third plurality of edges, coupling at least one attribute node of the one or more attribute nodes to another attribute node, of the plurality of attribute nodes. The processing circuitry further identifies the other attribute node based on the identified edge. The processing circuitry further determines a third message node of the set of message nodes based on the identified attribute node.

In some embodiments, the edge properties of the identified edge comprise (i) at least one attribute associated as node properties of the at least one attribute node, and (ii) at least one attribute associated as node properties of the other attribute node.

In some embodiments, the processing circuitry is further configured to generate the graph based on a plurality of messages and store the graph in the storage element. To generate the graph, the processing circuitry is further configured to instantiate a message node, of the plurality of message nodes, for each message of the plurality of messages. Each message has a plurality of attributes. The processing circuitry is further configured to associate the first set of attributes of the plurality of attributes of each message as the node properties of the instantiated message node. The processing circuitry is further configured to derive, from the plurality of attributes of each message, the second set of attributes that is shared with at least one other message of the plurality of messages. Further, the processing circuitry is configured to instantiate the set of attribute nodes that represents the second set of attributes. The processing circuitry is further configured to create the set of edges, of the first plurality of edges, between each message node and the set of attribute nodes. The processing circuitry is further configured to determine, for each edge of the set of edges, based on the plurality of attributes, the set of edge attributes. The processing circuitry is further configured to associate the set of edge attributes as the edge properties of each edge of the set of edges.

In some embodiments, to generate the graph, the processing circuitry is further configured to create an edge between two instantiated message nodes. Further, the processing circuitry is configured to determine, based on the plurality of attributes of each message represented by the two instantiated message nodes, another set of edge attributes. The processing circuitry is configured to associate the other set of edge attributes as the edge properties of the edge created between the two instantiated message nodes.

In some embodiments, the graph corresponds to a directed property graph.

In some embodiments, each message corresponds to at least one of a group consisting of a command message, a query message, or an event message.

In some embodiments, a method is disclosed. The method comprises receiving, by processing circuitry, a query that is indicative of a set of time-series computation functions to be executed in a graph. The graph comprises a plurality of message nodes and a plurality of attribute nodes, with each message node of the plurality of message nodes representing a message, has a first set of attributes of the message associated as node properties thereof, and is associated with a set of attribute nodes, of the plurality of attribute nodes, that represents a second set of attributes of the message. The method further comprises identifying, by the processing circuitry, based on the query, one or more attribute nodes from the plurality of attribute nodes. The method further comprises determining, by the processing circuitry, based on the one or more attribute nodes, a set of message nodes of the plurality of message nodes. The method further comprises identifying, by the processing circuitry, from the node properties of each of the set of message nodes, one or more attributes that are required for execution of the set of time-series computation functions. Each of the one or more attributes corresponds to a message timestamp. The method further comprises executing, by the processing circuitry, the set of time-series computation functions based on the identified one or more attributes of each of the set of message nodes.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a block diagram that illustrates a system environment for time-series message management using directed property graphs, consistent with disclosed embodiments of the present disclosure;

FIG. 2 is a block diagram that illustrates composition of a message, consistent with disclosed embodiments of the present disclosure;

FIG. 3 is a graph illustrating association between message and attribute nodes, consistent with disclosed embodiments of the present disclosure;

FIG. 4 is a graph illustrating a compact view of correlation between message nodes, consistent with disclosed embodiments of the present disclosure;

FIG. 5 is a time-sequence diagram that illustrates a sequence in which the milestones associated with the correlated messages of FIG. 4 are achieved, consistent with disclosed embodiments of the present disclosure;

FIG. 6 is a graph illustrating time-series computation using a single message node, consistent with disclosed embodiments of the present disclosure;

FIG. 7 is a graph illustrating time-series computation using multiple message nodes, consistent with disclosed embodiments of the present disclosure;

FIG. 8 is a graph illustrating another time-series computation using multiple message nodes, consistent with disclosed embodiments of the present disclosure;

FIG. 9 is a schematic diagram that illustrates an example implementation of time-series message management in a graph, consistent with disclosed embodiments of the present disclosure;

FIG. 10 illustrates an example computing system for carrying out the methods of the present disclosure, consistent with disclosed embodiments of the present disclosure; and

FIG. 11 represents a flowchart that illustrates a method for facilitating time-series message management using directed property graphs, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Conventionally, to facilitate data search operations, messages generated in an ecosystem may be stored in a directed property graph. Such messages include information associated with the tasks that are to be performed by various modules of the ecosystem. Thus, such messages provide information regarding various aspects of the modules, and can be analyzed for improving the performance of the modules, for making changes in the ecosystem, or the like. In the directed property graph, a message may be stored as a message node, with two message nodes being coupled by way of an edge indicating an association therebetween. Each message may have various attributes, such as an identifier (ID), a correlation ID, a created-on timestamp, a processed-on timestamp, a category, a topic, a name, or the like. These attributes form the transactional information that is required to be analyzed for deriving real-time analytical insights associated with the ecosystem. Specifically, time-series computation functions may be executed based on one or more message timestamps (e.g., the created-on timestamp, the processed-on timestamp, or the like) associated with the messages. A message timestamp may be indicative of a milestone associated with a message.

Traditionally, the attributes may be associated as node properties of the message node. In such a scenario, to identify message timestamps, each node property of each message node may be required to be searched. This approach may be inefficient and time-consuming as the directed property graph may have millions of message nodes. Such query processing may cause delays which may prove fatal in time-critical tasks. Additionally, the delays may further hinder time-series computations, leading to the generation of outdated analytics information. The use of such outdated analytics information may be harmful rather than beneficial to the communication among the modules. An alternative implementation may include storing attributes as attribute value nodes and coupling them to the message node via edges. In such a scenario, while the query processing may be less intensive as compared to the previous approach, instantiating a value node for each attribute of each message may be costly in terms of memory utilization. Therefore, both conventional approaches may prove to be inadequate in fulfilling the current requirement of fast and efficient query processing for real-time tasks.

The present disclosure provides a unique approach to the directed property graph implementation that leads to optimized query processing. The present disclosure discloses a graph (e.g., a directed property graph) generated using various messages associated with a real-time system. For each message, a message node may be instantiated in the graph. One or more attributes of a message may be associated as node properties of the corresponding message node. Further, attributes of the message that are shared with other messages may be determined and instantiated as attribute nodes in the graph. Edges may be created between the message node and the attribute nodes, with each edge indicating an association between the message node and the corresponding attribute node. Further, some attributes of the message may also be associated as edge properties of the edge. The attributes selected for the association as the edge properties may indicate the association between the message node and the corresponding attribute node. Additionally, some attributes may be associated as node properties of each attribute node.

Such a graph structure ensures that exclusively the essential attributes are represented as attribute nodes in the graph. In such a graph, the processing of a query may start from an attribute node or an edge. In both cases, the node properties of the attribute node and/or the edge properties of the edge may be utilized to identify message nodes. Once the message nodes are identified, the node properties of the identified message nodes may be searched to retrieve the message timestamps required for the execution of time-series computation functions indicated in the query. Further, the time-series computation functions may be executed based on the identified timestamps. Utilization of such a graph facilitates quick identification of the message nodes. Therefore, additional database lookups of searching each message node in the graph may be preserved. It is appreciated that the human mind is not equipped to conceptualize an optimized association of attributes with a corresponding message node in the directed property graph, given the digital interconnectedness of the association.

The present disclosure provides numerous advantages including optimized and organized association of attributes with a corresponding message node. Additionally, storing only the required attributes as attribute nodes may further result in optimized memory utilization. Notably, the excessive database look-ups may be prevented which may further lead to fast query processing with significant ease and reduced time consumption.

### Figure Description

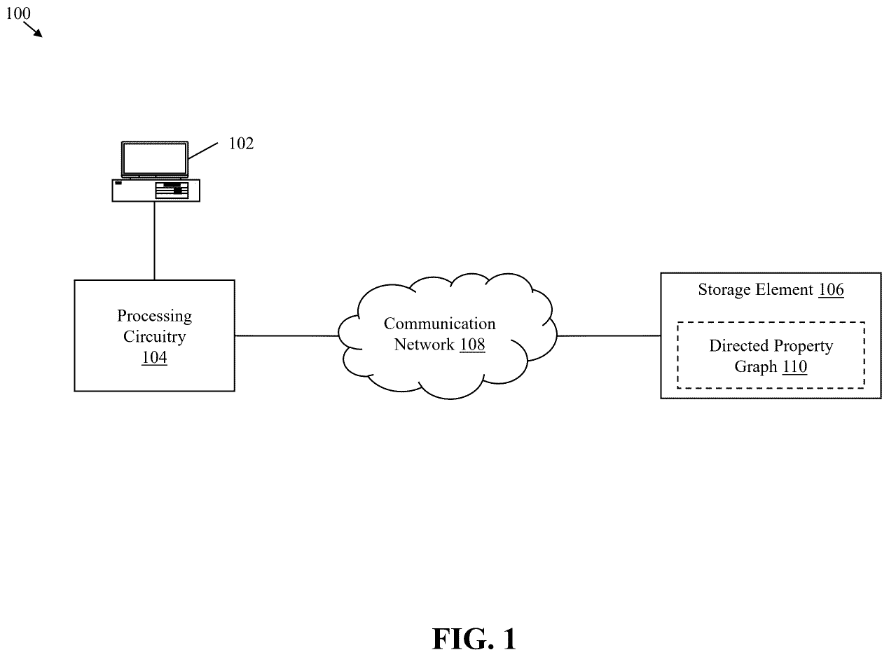

FIG. 1 is a block diagram that illustrates a system environment 100 for time-series message management using directed property graphs, consistent with disclosed embodiments of the present disclosure. In today's fast-paced world, different domains such as finance, healthcare, manufacturing processes, industrial processes, or the like, require real-time analytics for quick and efficient decision-making. Real-time analytics may require optimization at every stage of problem-solving. The data required for performing the analytics is typically stored in databases. Hence, for real-time analytics, database lookups are required to retrieve the data efficiently. A database look-up may involve retrieving data from a database by querying the database. For real-time analytics, where data is constantly collected and analyzed, excessive database lookups may impose various inefficiencies such as slow query processing, delayed analytics, degraded user experience, or the like. Therefore, reduced database lookups with efficient query processing may be required to optimize decision-making.

Typically, a real-world problem may be distributed across different services, with each component of the problem being handled by a specific service. These services may be referred to as microservices. A microservice may be specifically designed to execute a particular task. Upon execution of the task, the microservice may generate a message that may include transactional information associated with the task. These messages may be associated with one or more message timestamps such as a created-on timestamp, a raised-on timestamp, a received-on timestamp, a handled-on timestamp, or a processed-on timestamp. These messages may be stored in a database for various purposes. For example, real-time analytics for decision-making may be obtained using the message timestamps stored in the databases. The decision-making may involve improving the performance of various modules of real-time systems, modifying the real-time systems, or the like. In this scenario, the decision-making may inherently depend on the efficient retrieval of transactional information associated with the messages. The efficient retrieval may depend on how the transactional information is stored in the database. Therefore, the determination of the data storage structure may be important for real-time analytics and decision-making.

Traditionally, the transactional information may be stored in directed property graphs. A directed property graph is a graph data model consisting of nodes, edges, and properties, where edges have direction and both nodes and edges can store key-value pairs, allowing for complex data representation and efficient querying. Typically, the entire transactional information may be stored in directed property graphs as node properties or as value nodes. In the first scenario, the query processing may be inefficient and time-consuming, whereas the second scenario may be costly in terms of memory utilization. Therefore, these approaches may be inadequate in fulfilling the current requirement of fast and efficient query processing for real-time tasks.

The present disclosure provides a solution to implement faster query processing, and in turn, faster time-series computations and efficient real-time analysis, by storing messages in directed property graphs with exclusively the essential part of the transactional information being stored as nodes in directed property graphs. Such storage of messages and utilization of the messages for real-time analytics are explained in detail below.

Referring to FIG. 1, the system environment 100 may include a real-time system 102, processing circuitry 104, a storage element 106, and a communication network 108. The processing circuitry 104 is configured to access the storage element 106 via the communication network 108.

The real-time system 102 may represent a distributed platform that encompasses various microservices for the resolution of real-world problems. Each microservice handling a particular task associated therewith may generate/publish a message at the end of the task execution. The published message may correspond to an output of the microservice. The published message may be associated with message timestamps such as a created-on timestamp, a raised-on timestamp, a published-on timestamp, or the like. Other microservices associated with the real-time system 102 may subscribe to and process the published message. Upon being subscribed, the published message may be associated with a subscribed-on timestamp, whereas upon being processed, the published message may be associated with a processed-on timestamp. Thus, various microservices may communicate with each other by way of messages.

The processing circuitry 104 may include suitable logic, circuitry, interfaces, and/or code, executable by the circuitry, that may be configured to perform optimized time-series computations. The processing circuitry 104 may be configured to generate (e.g., derive) a directed property graph 110 based on the messages associated with the real-time system 102, and store the directed property graph 110 in the storage element 106. Examples of the storage element 106 may include, but are not limited to, a random-access memory (RAM), a read-only memory (ROM), a removable storage drive, a hard disk drive (HDD), a flash memory, a solid-state memory, or the like.

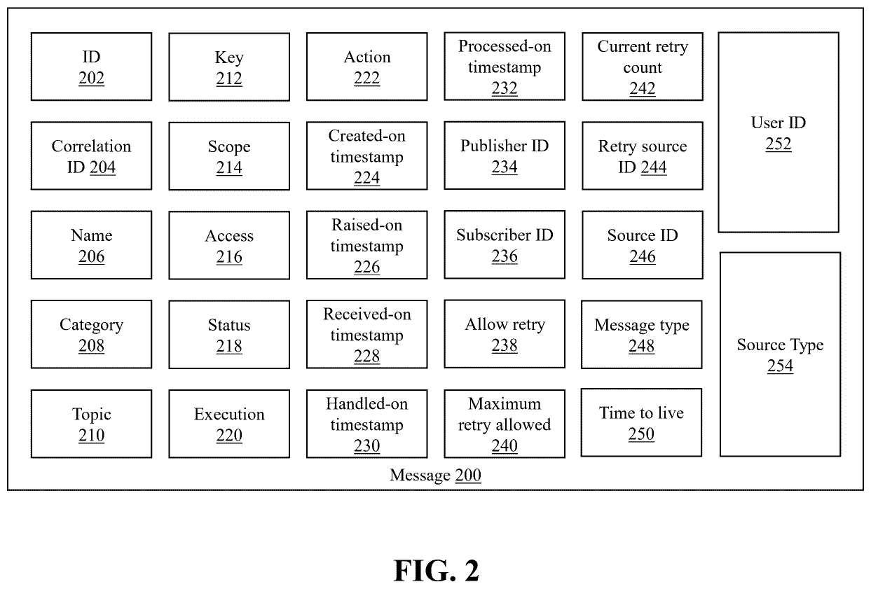

Each message may be associated with various attributes that may correspond to transactional information associated with the real-time system 102. The transactional information may define the composition of the message. Various attributes associated with the message may include an identifier (ID), a correlation ID, a user ID, a name, a category, a topic, a key, a scope, an access, a status, an execution, an action, a message type, a created-on timestamp, a raised-on timestamp, a received-on timestamp, a handled-on timestamp, a processed-on timestamp, a publisher ID, a subscriber ID, an allow retry, a maximum retry allowed, a retry count, a retry source ID, a source ID, a source type, or the like. The composition of the message is described in detail in conjunction with FIG. 2.

### Generation of the Directed Property Graph 110

To generate the directed property graph 110, the processing circuitry 104 may execute various operations. For example, the processing circuitry 104 may be configured to instantiate a message node for each unique message associated with the real-time system 102. Each message may have a plurality of attributes associated therewith. The processing circuitry 104 may be further configured to associate some of the attributes as node properties of each message node. Examples of such attributes may include the ID, the name, the category, the topic, the key, the scope, the access, the status, the execution, the action, the message type, the created-on timestamp, the raised-on timestamp, the received-on timestamp, the handled-on timestamp, the processed-on timestamp, the publisher ID, the subscriber ID, the allow retry, the maximum retry allowed, the retry count, the retry source ID, the source ID, the source type, or the like.

Some attributes of a message may be shared with at least one other message of the real-time system 102. For example, two or more messages may have a causal association therebetween and in such cases, may share data values of one or more attributes. To generate the directed property graph 110, the processing circuitry 104 may be further configured to derive a set of shared attributes of each message, and instantiate a set of attribute nodes that may represent the set of shared attributes, respectively. Examples of the shared attributes may include the ID, the correlation ID, the user ID, the created-on timestamp, the raised-on timestamp, the received-on timestamp, the handled-on timestamp, the processed-on timestamp, or the like. In the present disclosure, the sharing of an attribute corresponds to the sharing of a unique data value. For example, an ID of a message may correspond to a source ID of another message. In such a scenario, the ID (e.g., the data value of the ID attribute) is the shared attribute.

For each attribute node, the processing circuitry 104 may be configured to determine a set of attributes and associate the determined set of attributes as node properties of the corresponding attribute node. For each attribute node, the determined set of attributes may be linked with a shared attribute represented by the corresponding attribute node. The processing circuitry 104 may be further configured to create one or more edges between the message node and the one or more attribute nodes, respectively. Further, for each edge, the processing circuitry 104 may be configured to determine one or more edge attributes that may be indicative of an association between the message node and the corresponding attribute node, and associate the determined edge attributes as edge properties of the corresponding edge. Additionally, the processing circuitry 104 may be configured to create edges between two message nodes. For each edge, the processing circuitry 104 may be configured to determine edge attributes that may be indicative of an association between the two message nodes, and associate the determined edge attributes as edge properties of the corresponding edge.

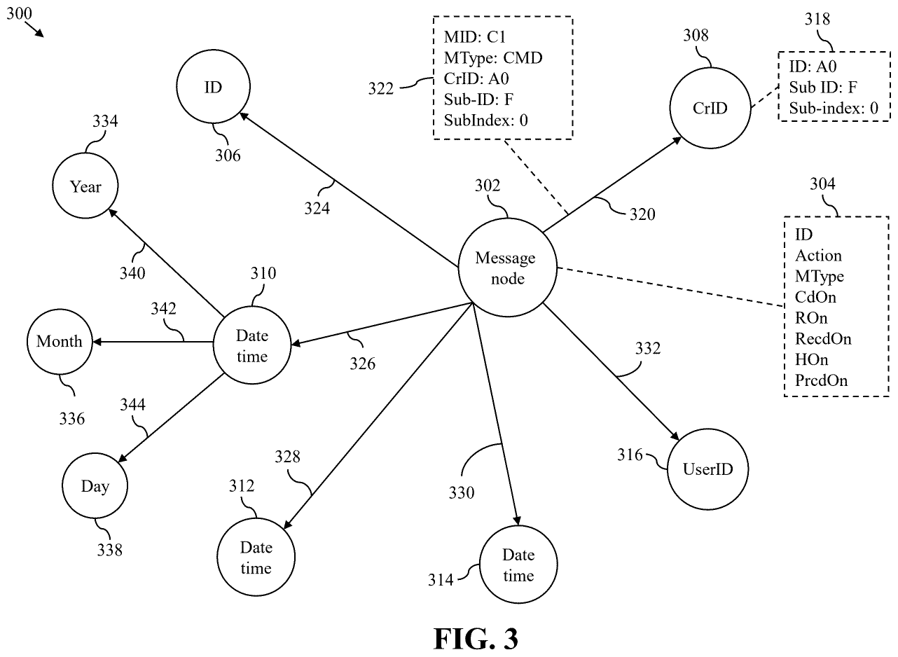

The aforementioned operations may be executed for all messages associated with the real-time system 102. Further, such a graph generation may result in one or more attribute nodes being associated with two or more message nodes. Thus, the directed property graph 110 may indicate various associations and relationships between the messages. Such a structure of the directed property graph 110 may facilitate optimized query processing. The structure of the directed property graph 110 is explained in detail in conjunction with FIGS. 3-8.

### Query Processing

In an embodiment, the processing circuitry 104 may receive a query. The query may be indicative of a set of time-series computation functions to be executed in the directed property graph 110. To execute the set of time-series computation functions, a search may be executed on the messages stored in the directed property graph 110. The processing circuitry 104 may be configured to identify, in the directed property graph 110, one or more attribute nodes based on the query. In an embodiment, the one or more attribute nodes may have data values associated with (e.g., identical to) one or more reference values included in the query. Based on the one or more attribute nodes, the processing circuitry 104 may be further configured to determine a set of message nodes of the directed property graph 110. To determine the set of message nodes, the processing circuitry 104 may be further configured to identify edges associated with the one or more attribute nodes. In an embodiment, the edges may be coupling the one or more attribute nodes to the set of message nodes, with one attribute node being coupled to two or more message nodes by way of two or more edges, respectively. Thus, the set of message nodes may be determined directly using the identified edges.

The scope of the present disclosure is not limited to the query processing described above. In another embodiment, the processing circuitry 104 may be configured to identify, in the directed property graph 110, one or more edges having edge properties associated with the reference values included in the query. The processing circuitry 104 may be further configured to determine the set of message nodes based on the edge properties of the identified edges.

The scope of the present disclosure is not limited to the determination of the message nodes directly from the attribute nodes identified based on the query. In an embodiment, the processing circuitry 104 may be further configured to identify one or more edges associated with the one or more attribute nodes, respectively. The one or more edges may be coupling the one or more attribute nodes to one message node (e.g., a first message node). The first message node may thus be determined based on the one or more edges and/or the edge properties of the one or more edges. After determining the first message node, the processing circuitry 104 may be further configured to identify an edge coupling the first message node to a second message node, and determine the second message node based on the edge properties of the identified edge. Further, the processing circuitry 104 may be configured to identify an edge coupling at least one attribute node of the one or more attribute nodes to another attribute node of the directed property graph 110, and identify the other attribute node based on the identified edge. This identified attribute node may be used to determine another message node (e.g., a third message node) in a manner similar to the determination of the first message node. In such a scenario, the first through third message nodes may constitute the set of message nodes. Thus, some of the set of message nodes may be determined directly from the attribute nodes identified based on the query, whereas some may be determined indirectly using other attribute nodes or already determined message nodes.

The processing circuitry 104 may be further configured to identify, from node properties of each of the set of message nodes, one or more attributes required for the execution of the set of time-series computation functions. Each of the one or more attributes may correspond to a message timestamp. Each message timestamp identified from each message node of the set of message nodes corresponds to one of a group consisting of a created-on timestamp, a raised-on timestamp, a received-on timestamp, a handled-on timestamp, or a processed-on timestamp associated with the message represented by the corresponding message node. Thus, each message timestamp identified from each message node of the set of message nodes is indicative of a milestone associated with the message represented by the corresponding message node, with the milestone corresponding to one of a group consisting of a creation event, a raise event, a subscription event, a handle event, or a process event.

The processing circuitry 104 may be further configured to execute the set of time-series computation functions based on the identified one or more attributes of each of the set of message nodes. In an embodiment, the set of time-series computation functions may include one or more mathematical computations that, when executed on the identified one or more attributes of each of the set of message nodes, generate a set of computation outputs indicative of system performance (e.g., performance of the real-time system 102). In such cases, the processing circuitry 104 may be further configured to generate an analytics outcome by executing one or more database operations on the set of computation outputs. The database operations may include at least one of a group consisting of an intersection operation or a union operation. In another embodiment, each time-series computation function of the set of time-series computation functions includes one or more parameters, where one or more parameter values of the one or more parameters, respectively, are derived from the identified one or more attributes of each of the set of message nodes. In such cases, the processing circuitry 104 may be further configured to define the one or more parameters of each time-series computation function based on one of a group consisting of one or more message milestones or a user input. Further, the processing circuitry 104 may execute each time-series computation function based on the derived one or more parameter values, and based on the execution of the set of time-series computation functions, the analytics outcome may be generated.

Thus, to create the directed property graph 110, relationships between messages are analyzed based on the data values of the attributes shared therebetween. Associations of such attributes as attribute nodes allow faster query processing as the correlated one or more message nodes may be identified by identifying the shared attribute node. Further, the association of other attributes as node properties prevents unnecessary database lookups as well allows efficient memory utilization. Relationships between one or more messages may be further analyzed based on the edge properties associated with each edge. Therefore, traversing to relevant message nodes for query processing is effectively optimized by analyzing the optimized relationships and generating a streamlined structure associated with the directed property graph 110 for efficient query processing.

The processing circuitry 104 may be implemented by one or more processors, such as, but not limited to, an application-specific integrated circuit (ASIC) processor, a reduced instruction set computer (RISC) processor, a complex instruction set computer (CISC) processor, and a field programmable gate array (FPGA) processor. The one or more processors may also correspond to central processing units (CPUs), graphics processing units (GPUs), neural processing units (NPUs), digital signal processors (DSPs), or the like. It will be apparent to a person of ordinary skill in the art that the processing circuitry 104 may be compatible with multiple operating systems. The processing circuitry 104 may further include one or more components (for example, a parser, a loader, or the like) that may be configured to execute one or more operations to be executed by the processing circuitry 104.

The communication network 108 is a medium through which data and instructions are transmitted between the processing circuitry 104 and the storage element 106. Examples of the communication network 108 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, microwave communication, and a combination thereof. Examples of the communication network 108 may further include a Narrow Band-Internet of Things (NB-IoT) network, a 5G network, a 4G network, a long-range (LoRa) wireless technology network, a ZigBee network, an Ipv6 Low-power Wireless Personal Area Network (6LowPAN), or the like. Various entities (such as the processing circuitry 104 and the storage element 106) in the system environment 100 may be coupled to the communication network 108 in accordance with various wired and wireless communication protocols, such as Transmission Control Protocol and Internet Protocol (TCP/IP), User Datagram Protocol (UDP), Long Term Evolution (LTE) communication protocols, or any combination thereof.

Although the present disclosure describes the generation and utilization of a directed property graph (e.g., the directed property graph 110), the scope of the present disclosure is not limited to it. In numerous embodiments, the other types of graphs, such as undirected graphs, weighted graphs, bipartite graphs, or the like, may be utilized without deviating from the scope of the present disclosure.

The scope of the present disclosure is not limited to a standalone realization of the storage element 106, as described herein. In numerous embodiments, the storage element 106 can be realized in the form of a database server or a cloud storage working in conjunction with the processing circuitry 104, without departing from the scope of the present disclosure.

FIG. 2 is a block diagram that illustrates composition of a message 200, consistent with disclosed embodiments of the present disclosure. The message 200 may correspond to one of a command-type message, a query-type message, or an event-type message. The message 200 may be associated with the real-time system 102. The message 200 may include data and transactional information. Data included in the composition of the message 200 may refer to the message payload. In other words, the data in the composition of the message 200 refers to a statement, an instruction, a message, a command, a query, or the like, that is being communicated via the message 200.

Referring to FIG. 2, the composition of the message 200 includes a plurality of attributes that form the transactional information associated with the message 200. The plurality of attributes may include an ID 202, a correlation ID 204, a name 206, a category 208, a topic 210, a key 212, a scope 214, an access 216, a status 218, an execution 220, an action 222, a created-on timestamp 224, a raised-on timestamp 226, a received-on timestamp 228, a handled-on timestamp 230, a processed-on timestamp 232, a publisher ID 234, a subscriber ID 236, an allow retry 238, a maximum retry allowed 240, a current retry count 242, a retry source ID 244, a source ID 246, a message type 248, a time to live 250, a user ID 252, and a source type 254. Though the data associated with the message 200 is not shown in FIG. 2, it will be apparent to a person skilled in the art that the composition of the message 200 includes the data to be communicated by the message 200.

The ID 202 is a unique ID associated with the message 200 and may be used by the processing circuitry 104 to identify the message 200.

The correlation ID 204 is an ID that is shared among messages that are related. The correlation ID 204 may be used to join and correlate one or more messages in a transaction flow such as a command-to-event, a query-to-event, or the like. Each sub-message (e.g., child message) of a compound message (e.g., parent message) may include a hierarchical correlation ID. Further, sub-messages at the same level of hierarchy may have identical data values for the correlation ID 204. Sub-messages at each subsequent hierarchical level may further include data values of the correlation ID 204 of sub-messages at previous hierarchical levels. Each sub-message may also include a root ID that is associated with the parent message.

The name 206 is a human-understandable descriptor of the message 200 and is solely included for the ease of understanding of users associated with the real-time system 102.

The category 208 is a human-understandable descriptor of a domain or criterion of the message. For example, a data value of the category 208 of the message 200 may be an order management message.

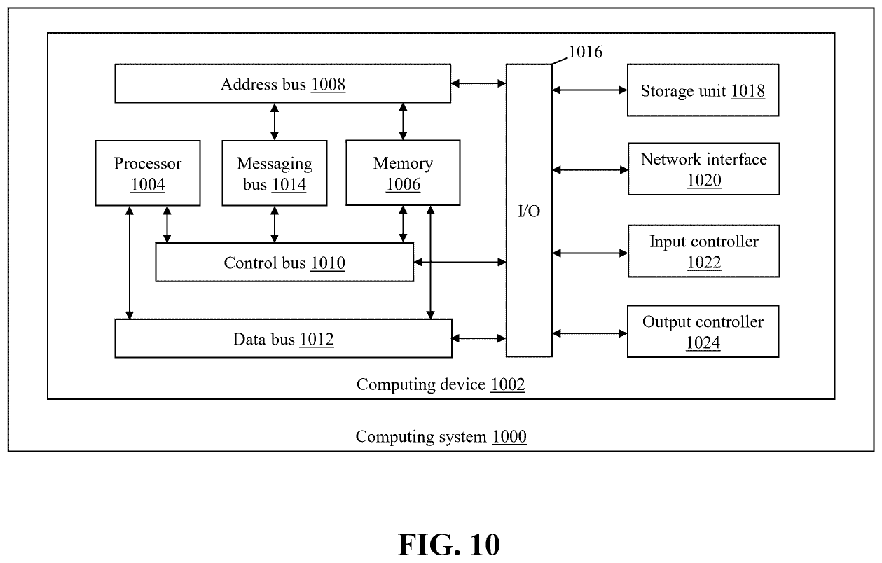

The topic 210 is a human-understandable descriptor of a topic/domain/subject/agenda associated with which the message 200 has been published. Notably, the topic 210 allows the grouping of multiple messages irrespective of their category. Each message may be associated with a single data value of the topic 210. Notably, multiple messages may be associated with the same data value of the topic 210. Each data value of the topic 210 may have one or more subscribers (for example, one or more microservices). The subscriber may handle the message 200 associated with a topic. Each data value of the topic 210 may be published/scheduled for processing using a specific pipeline of a messaging bus (shown in FIG. 10).

The key 212 corresponds to a unique ID associated with a root data node for which the message 200 may be created. The root data node may be further processed by one or more messages, each representing a different transaction. In such a case, the data value for the key attribute of the one or more messages may be identical to the data value of the key 212 associated with the message 200. The identical data value of the key associated with the one or more messages may allow to maintain an order of the one or more messages in a message queue within the topic 210 based on the processing of the one or more messages on the root data node. Further, the key 212 is used to establish a single partition in the message queue of a messaging system (for example, Kafka) such that the one or more messages may be stored and consumed in the exact order they were produced. In an embodiment, if the root data node is processed by two different transactions, i.e., by two different messages, the processing order of the two messages may be maintained for one or more handler microservices that may subscribe to these messages. Utilization of the key 212 allows the sending of these messages to the same partition so that the one or more handler microservices may subscribe to these messages from the same partition.

The scope 214 ensures appropriate security of the message 200. Data values of the scope 214 may be internal or external. When the data value of the scope 214 is internal, the message 200 may be internal, e.g., the message 200 may be communicated between one or more microservices associated with a host system. Alternatively, when the data value of the scope 214 is external, the message 200 may be external, e.g., the message 200 may be communicated between a microservice associated with a native system and different microservices associated with an external system. Therefore, the data value of the scope 214 may be one of internal, external, or internal and external.

The access 216 determines access permission to the message 200. In an instance, when a data value of the access 216 is public, a user trying to access the message 200 is not required to be authenticated prior to the access. In another instance, when the data value of the access 216 is private, a user trying to access the message 200 is required to be authenticated prior to accessing the message 200.

The status 218 is indicative of the progress of execution of the message 200. A data value of the status 218 of the message 200 may be one of created, raised, received, handled, or processed.

The execution 220 is indicative of a path that is to be traveled by the message 200 to reach its destination node. The data value of the execution 220 may be synchronous or asynchronous. In an instance, when the data value of the execution 220 is asynchronous, the message 200 may follow a transaction path that is loosely coupled. That is to say, the message 200 generated by a producer microservice may be communicated to a consumer microservice by way of a message-oriented middleware, such as Kafka, RabbitMQ, or the like. In another instance, when the data value of the execution 220 is synchronous, the message 200 may follow a transaction path that is not loosely coupled. For example, in the case of an application using a messaging mechanism, a built-in application programming interface (API) may be utilized that may allow communication of the message 200 within the application without relying on an external message-oriented middleware.

The action 222 is indicative of an action or operation to be performed by a microservice that subscribes to the message 200.

The created-on timestamp 224 includes details (such as time, date, day, month, or the like) regarding the creation of the message 200 by its source microservice.

The raised-on timestamp 226 includes details (such as time, date, day, month, or the like) regarding the publication of the message 200 on a communication bus by its source microservice. The communication bus forms a channel between a source microservice and a destination microservice of the message.

The received-on timestamp 228 includes details (such as time, date, day, month, or the like) regarding when the message 200 was received by the destination microservice but has not been processed.

The handled-on timestamp 230 includes details (such as time, date, day, month, or the like) associated with a point in time when the processing of the message 200 is initiated.

The processed-on timestamp 232 includes details (such as time, date, day, month, or the like) regarding when the processing of the message 200 gets completed.

The publisher ID 234 is a unique ID for a publisher microservice that has published the message 200. A data value of the publisher ID 234 may be associated with the source microservice or an intermediate microservice.

The subscriber ID 236 is a unique ID for a handler microservice(s) that subscribes to the message 200. Notably, a command-type message and a query-type message may be subscribed to by a single microservice, whereas an event-type message may be subscribed to by multiple microservices and each microservice may receive a copy of the event-type message.

The allow retry 238 ensures successful communication and processing of the message 200. A data value of the allow retry 238 determines if the message 200 is to be re-published in case the status of the message 200 is a failure or partial failure. The re-published message may be a clone of the original message 200.

The maximum retry allowed 240 determines the maximum count for which the message 200 is to be re-published in case the status of the message 200 is a failure or partial failure.

The current retry count 242 keeps track of a number of times for which the message 200 is re-published. That is to say that the current retry count 242 is indicative of a current count of re-publications of the message 200. The data value of the current retry count 242 is incremented with each re-publication of the message 200.

The retry source ID 244 included in the message 200 is a unique ID of an original message that is being re-published. The retry source ID 244 is required as a clone message with a different ID is generated and published during the re-publication of the message 200. The clone message has timestamps (e.g., a created-on timestamp, a received-on timestamp, or the like) that are different from the timestamps included in the message 200. Therefore, to link the clone message to the message 200, a data value of the retry source ID 244 is included in the clone message.

The source ID 246 represents an object that initiated the message creation. For example, if a user experience (UX) initiates a transaction, the data value of the source ID 246 may correspond to the data value of an ID of the UX control/page. In another embodiment, the source ID 246 is included in the message 200 if the message 200 has originated from another message. For example, an event-type message that is created in response to the processing of a command-type message may have a data value of the source ID 246 that is identical to the data value of the ID 202 of the command-type message.

The message type 248 is indicative of the message 200 being one of a command message, a query message, or an event message. The message type 248 may further include a flag, where a value ‘1’ of the flag may indicate that the message represented by the message 200 is a leaf message, whereas a value ‘0’ of the flag may indicate that the message 200 is a composite message. The leaf message does not have any sub-messages, whereas the composite message is a message having one or more sub-messages. In other embodiments, composite and leaf messages may be indicated differently without deviating from the scope of the disclosure.

The time to live 250 may be indicative of a time period during which the message 200 may be valid. Therefore, the message should be communicated and processed within a duration that is indicated by a data value of the time to live 250. In an instance of failure or partial failure, the message 200 should not be re-published once the time period indicated by the data value of the time to live 250 has lapsed. Notably, the lapse of the time period indicated by the data value of the time to live 250 is indicative of message 200 being invalid.

The user ID 252 has a corresponding data value that is a unique ID associated with a user of the real-time system 102 that may have generated the message 200.

The source type 254 refers to a source that may have caused the generation of the message 200. In an embodiment, a data value of the source type 254 may be one of command, query, or event. In another embodiment, the data value of the source type 254 may be a non-message type.

The composition of the message 200 described in FIG. 2 may be used by the processing circuitry 104 for performing the analysis of the message 200. Such analysis may be performed to determine one or more analytical insights related to the performance of the business solution associated with the real-time system 102.

The plurality of attributes associated with the message 200 may include one or more attributes that comprise static information and one or more attributes that comprise dynamic information. The static information may be assigned to the one or more attributes at the time of the creation of the message 200, whereas the dynamic information may be assigned to the one or more attributes during the processing of the message 200. The one or more attributes with static information may correspond to ID 202, the correlation ID 204, the name 206, the category 208, the topic 210, the key 212, the scope 214, the access 216, the execution 220, the action 222, the allow retry 238, the maximum retry allowed 240, the retry source ID 244, the source ID 246, the source type 254, and the user ID 252. Further, the one or more attributes with dynamic information may correspond to the status 218, the created-on timestamp 224, the raised-on timestamp 226, the received-on timestamp 228, the handled-on timestamp 230, the processed-on timestamp 232, the publisher ID 234, the subscriber ID 236, and the current retry count 242.

It will be apparent to a person skilled in the art that the composition of the message 200 described in conjunction with FIG. 2 is non-limiting, and in other embodiments, components included in the message 200 may differ from the components depicted in FIG. 2.

FIG. 3 is a graph 300 illustrating association between message and attribute nodes, consistent with disclosed embodiments of the present disclosure. The graph 300 may correspond to a portion of the directed property graph 110. Referring to FIG. 3, the processing circuitry 104 may be configured to instantiate a message node 302 in the graph 300 that may represent the message 200.

The processing circuitry 104 may be further configured to associate at least one of the plurality of attributes associated with the message 200 as node properties of the message node 302. The node properties of the message node 302 are shown within a dotted box 304 associated with the message node 302. In the example illustrated in FIG. 3, the node properties may include the ID 202, the action 222, the message type 248 (denoted as “MType” in FIG. 3), the created-on timestamp 224 (denoted as “CdOn” in FIG. 3), the raised-on timestamp 226 (denoted as “ROn” in FIG. 3), the received-on timestamp 228 (denoted as “RecdOn” in FIG. 3), the handled-on timestamp 230 (denoted as “HOn” in FIG. 3), and the processed-on timestamp 232 (denoted as “PrcdOn” in FIG. 3). However, other node properties such as the name 206, the category 208, the topic 210, the key 212, the scope 214, the access 216, the status 218, the execution 220, the publisher ID 234, the subscriber ID 236, the allow retry 238, the maximum retry allowed 240, the current retry count 242, the retry source ID 244, or the source ID 246 may also be associated as the node properties of the message node 302. Data values of the attributes are not shown in FIG. 3 to keep the illustration concise and clear, and should not be considered a limitation of the present disclosure.

The processing circuitry 104 may be further configured to derive a set of shared attributes from the plurality of attributes associated with the message 200 and instantiate a set of attribute nodes 306-316 in the graph 300 representing the set of shared attributes. For the sake of brevity, the set of shared attributes may include the ID 202, the correlation ID 204, the created-on timestamp 224, the received-on timestamp 228, the handled-on timestamp 230, and the user ID 252. However, other attributes (e.g., the raised-on timestamp 226 and the processed-on timestamp 232) may also be included in the set of shared attributes, without deviating from the scope of the present disclosure. The graph 300 may thus include the attribute node 306 that represents the ID 202, the attribute node 308 that represents the correlation ID 204, the attribute node 310 that represents the created-on timestamp 224, the attribute node 312 that represents the received-on timestamp 228, the attribute node 314 that represents the handled-on timestamp 230, and the attribute node 316 that represents the user ID 252.

The processing circuitry 104 may be further configured to determine, based on the plurality of attributes associated with the message 200, a set of attributes for each attribute node. The set of attributes may be linked with a shared attribute represented by the corresponding attribute node. The processing circuitry 104 may be further configured to associate the set of attributes as node properties of the corresponding attribute node. For example, for the attribute node 308 that represents the correlation ID 204, the ID 202, a sub-ID attribute, and a sub-index attribute may be associated as node properties of the attribute node 308. The node properties of the attribute node 308 are shown within a dotted box 318 associated with the attribute node 308 via a dotted line. The sub-ID and the sub-index attributes may be derived from the ID 202, the correlation ID 204, and the source ID 246 of the message 200. For example, if the message 200 represents a source message (e.g., the data value of the source ID 246 is ‘NULL’), the sub-ID attribute may be false. Conversely, if the message 200 is generated based on the processing of another message (e.g., the source ID 246 may indicate a different (source) message, and the correlation ID 204 may be identical to that of the source message), the sub-ID attribute may be true. Further, the hierarchical level at which the message 200 may be generated may be determined based on the value associated with the sub-index attribute. If the sub-index attribute corresponds to ‘0’, the message 200 may represent a parent message. Conversely, if the sub-index attribute corresponds to ‘1’, the message 200 may represent a first sub-message. Based on the node properties illustrated in FIG. 3, it can be determined that the message node 302 represents a root message as the sub-ID attribute is false (‘F’) and the sub-index attribute is ‘0’.

The processing circuitry 104 may be further configured to create a set of edges between the message node 302 and the attribute nodes 306-316. For example, the processing circuitry 104 may be configured to create an edge 320 between the message node 302 and the attribute node 308 that represents the correlation ID 204. In an example, the edge 320 may be named as message_correlation ID, where the message may correspond to the message node 302 and the correlation ID may correspond to the correlation ID 204 represented by the attribute node 308. The edge 320 may couple the message node 302 to the attribute node 308 by way of an out-role and an in-role. The out-role may define an origin, for example, the message node 302 of the edge 320, and the in-role may define a destination, for example, the attribute node 308 of the edge 320.

The processing circuitry 104 may be further configured to determine, for each edge, based on the plurality of attributes associated with the message 200, a set of edge attributes that is indicative of an association between the message node 302 and the corresponding attribute node. The set of edge attributes may include at least one attribute associated as the node properties of the message node 302 and at least one of the set of attributes associated as the node properties of the corresponding attribute node. Further, the processing circuitry 104 may be configured to associate the set of edge attributes as edge properties of the corresponding edge. In an example, the edge properties associated with the edge 320 may include the message ID (e.g., the ID 202), the message type 248, the correlation ID 204, the sub-ID attribute, and the sub-index attribute. In other words, the edge properties associated with the edge 320 may include at least one attribute associated as the node properties of the message node 302 (e.g., the ID 202, the message type 248, and the correlation ID 204) and at least one attribute associated as the node properties of the attribute node 308 (e.g., the sub-ID attribute and the sub-index attribute). The edge properties associated with the edge 320 are illustrated in a dotted box 322 in the form of a key-value pair. In an embodiment, where the message node 302 may represent a root message of command type and have an ID as ‘C1, the edge properties associated with the edge 320 may include the values ‘C1’, ‘CMD’, ‘A0’, ‘F’, and ‘0’ for the message ID, the message type 248, the correlation ID 204, the sub-ID attribute, and the sub-index attribute, respectively.

The processing circuitry 104 may be further configured to create edges 324-332 coupling the message node 302 to the attribute nodes 306, 310, 312, 314, and 316, respectively. The edges 324-332 may store the edge properties in a similar manner as described above.

In numerous embodiments, an attribute node may represent composite data. For example, the attribute node 310 that represents the created-on timestamp 224 may store composite data (e.g., a combination of year, month, and day). In such a scenario, the processing circuitry 104 may be further configured to instantiate attribute nodes 334-338 to represent year, month, and day values, respectively. Further, the processing circuitry 104 may be configured to create edges 340-344 to couple the attribute node 310 to the attribute nodes 334-338, respectively. The attribute nodes 334-338 and the edges 340-344 may be implemented in a similar manner as described above. The attribute nodes 312 and 314 may also represent composite data, and additional attribute nodes and edges may be implemented for the attribute nodes 312 and 314 in a similar manner as described above.

Other messages and compositions thereof may be created in the directed property graph 110 in a similar manner as described above. However, for a unique data value associated with an attribute, exclusively one attribute node is instantiated. That is to say, one or more message nodes, having the same data value for the attribute being created as an attribute node, may be associated with the same attribute node. In other words, any of the attribute nodes 306-316 and 334-338 may be shared between multiple message nodes.

The graph 300 facilitates the processing of a query associated with a system comprising the processing circuitry 104 and the storage element 106. For example, the processing circuitry 104 may receive a query indicative of a set of time-series computation functions. The reference value included in the query may correspond to an ID of a message on which the time-series computation functions are to be performed. For the sake of brevity, it is assumed that the reference value in the query matches the data value represented by the attribute node 306. Thus, the processing circuitry 104 may identify the attribute node 306.

Upon the identification of the attribute node 306, the processing circuitry 104 may be further configured to identify the edge 324 associated with the attribute node 306. The processing circuitry 104 may be further configured to identify the message node 302 based on the edge properties of the edge 324. The processing circuitry 104 may be configured to identify, from the node properties of the message node 302, one or more message timestamps required for the execution of the set of time-series computation functions. Further, the processing circuitry 104 may be configured to execute the set of time-series computation functions based on the identified message timestamps.

Utilizing the shared attribute nodes for searching the message nodes may facilitate efficient identification of message nodes. For example, in the absence of the attribute node 306, the processing circuitry 104 may be required to search the node properties of each message node. This may result in an expensive search (for example, extensive database lookups). Therefore, the attribute node 306 that represents the ID 202 may restrict the search to the message node 302, thereby enabling efficient query execution.

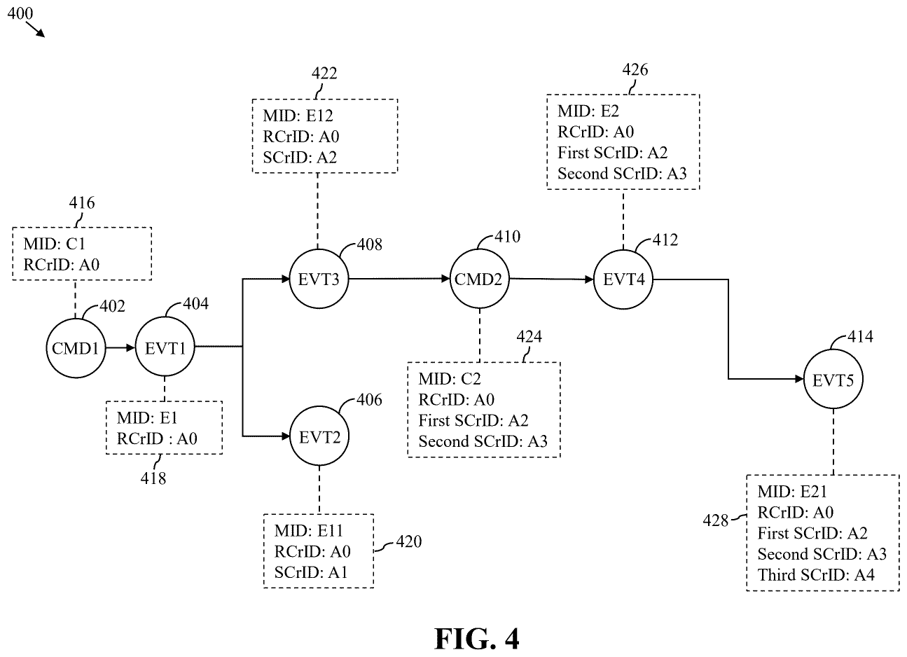

FIG. 4 is a graph 400 illustrating a compact view of correlation between message nodes, consistent with disclosed embodiments of the present disclosure. The graph 400 may correspond to a portion of the directed property graph 110. Various messages of the real-time system 102 may be correlated (e.g., various messages of the real-time system 102 may have a causal association therebetween). In an example, a first command message, a first event message, a second event message, a third event message, a second command message, a fourth event message, and a fifth event message may be correlated.

Referring to FIG. 4, the processing circuitry 104 may be configured to instantiate message nodes 402-414 in the graph 400 that may represent the first command message, the first event message, the second event message, the third event message, the second command message, the fourth event message, and the fifth event message, respectively. In an embodiment, the processing circuitry 104 may be further configured to associate at least one attribute with each of the message nodes 402-414 as node properties thereof. Some of the node properties associated with the message nodes 402-414 are illustrated in dotted boxes 416-428, respectively.

The message node 402 may be associated with an ID ‘C1’ and a root correlation ID ‘A0’. The ID ‘C1’ is unique and is used to identify the message node 402. The root correlation ID is indicative of a transactional operation associated with the root message (e.g., the first command message) for executing a first transaction in the real-time system 102 by a microservice associated therewith. Similarly, the message node 404 may be associated with an ID ‘E1’ and the root correlation ID ‘A0’. The message ID ‘E1’ is unique and is used to identify the message node 404. The association of the root correlation ID ‘A0’ with the message node 404 is indicative of a causal association between the message nodes 402 and 404. The term causal association is indicative of one message being generated based on the processing of another message. That is to say that the first event message is generated based on the processing of the first command message. Thus, the first command message is correlated with the first event message such that the first command message has a causal association with the first event message, and as a result, the message node 402 representing the first command message has a causal association with the message node 404 representing the first event message. The processing circuitry 104 may be further configured to create an edge between the message nodes 402 and 404 to indicate the association between them. The message node 402 may thus be a parent message node to the message node 404. The association of the root correlation ID ‘A0’ with the message node 404 is further indicative of the first event message being generated as a part of the execution of the first transaction associated with the message node 402.

Similarly, the second and third event messages may be generated based on the processing of the first event message. The second and third event messages may be cloned event messages of the first event message. The second and third event messages may be generated based on the subscription of the first event message by two subscribers (e.g., microservices). The message nodes 406 and 408 may thus represent the clones of the message node 404. The processing circuitry 104 may be further configured to create an edge between the message nodes 404 and 406, and another edge between the message nodes 404 and 408.

As illustrated in FIG. 4, the message node 406 may be associated with an ID ‘E11’, the root correlation ID ‘A0’, and a sub-correlation ID ‘A1’. Similarly, the message node 408 may be associated with an ID ‘E12’, the root correlation ID ‘A0’, and a sub-correlation ID ‘A2’. The association of the root correlation ID with the message nodes 406 and 408 indicates that the second and third event messages are generated as a part of the execution of the first transaction and that each of the message nodes 406 and 408 are child message nodes to the message nodes 402 and 404. The different sub-correlation IDs indicate distinct transactional operations associated with the two event messages (e.g., the second and third event messages). The association of the sub-correlation ID ‘A1’ with the message node 406 is indicative of a second transaction that is different from the first transaction. Further, the association of both the root correlation ID ‘A0’ and the sub-correlation ID ‘A1’ with the message node 406 is indicative of the second transaction being a sub-transaction to the first transaction. Similarly, the association of the sub-correlation ID ‘A2’ with the message node 408 is indicative of a third transaction that is different from but a sub-transaction to the first transaction. The message node 404 does not have a sub-correlation ID associated therewith as the first event message and the first command message are part of the same logical transaction.

The second command message may be generated based on the processing of the third event message. Thus, the processing circuitry 104 may be configured to create an edge between the message nodes 408 and 410. The message node 410 may be associated with an ID ‘C2’, the root correlation ID ‘A0’, a first sub-correlation ID ‘A2’, and a second sub-correlation ID ‘A3’. The association of the root correlation ID ‘A0’ and the first sub-correlation ID ‘A2’ with the message node 410 indicates that the second command message is generated as a part of the execution of the first transaction and that the message node 410 is a child message node to the message nodes 402, 404, and 408. The association of the second sub-correlation ID ‘A3’ with the message node 410 is indicative of a fourth transaction that is different from the third transaction. Further, the association of both the first sub-correlation ID ‘A2’ and the second sub-correlation ID ‘A3’ is indicative of the fourth transaction being a sub-transaction to the third transaction.

The message node 412 may be associated with an ID ‘E2’, the root correlation ID ‘A0’, the first sub-correlation ID ‘A2’, and the second sub-correlation ID ‘A3’. The message ID ‘E2’ is unique and is used to identify the message node 412. The association of the root correlation ID ‘A0’, the first sub-correlation ID ‘A2’, and the second sub-correlation ID ‘A3’ with the message node 412 indicates that the fourth event message is generated as a part of the execution of the first transaction and that the message node 412 is a child message node to the message node 402, 404, and 408. The message node 412 does not have a distinct sub-correlation ID associated therewith as the fourth event message and the second command message are part of the same logical transaction. The processing circuitry 104 may be configured to create an edge between the message nodes 410 and 412.

The fifth event message may be generated based on the processing of the second command message. The first command message, the first event message, the second event message, the third event message, the second command message, the fourth event message, and the fifth event message may thus be correlated and are collectively referred to as “correlated messages”. The processing circuitry 104 may be further configured to create an edge between the message nodes 412 and 414. The edges are not labeled in FIG. 4 to keep the illustration concise and clear, and should not be considered a limitation of the present disclosure.

As illustrated in FIG. 4, the message node 414 may be associated with an ID ‘E21’, the root correlation ID ‘A0’, the first sub-correlation ID ‘A2’, the second sub-correlation ID ‘A3’, and a third sub-correlation ID ‘A4’. The message ID ‘E21’ is unique and is used to identify the message node 414. The association of the root correlation ID ‘A0’ with the message node 414 is indicative of a causal association between the message nodes 412 and 414. The association of the root correlation ID ‘A0’ with the message node 414 is further indicative of the fifth event message being generated as a part of the execution of the first transaction and that the message node 414 is a child message node to the message nodes 402, 404, 408, 410, and 412. Further, the association of the third sub-correlation ID ‘A4’ with the message node 414 is indicative of a fifth transaction that is different from the third transaction.

The association of a common correlation ID (e.g., the root correlation ID ‘A0’) with two or more message nodes is indicative of a causal association therebetween. Further, the association of a new correlation ID (e.g., the sub-correlation IDs ‘A1’, ‘A2’, ‘A3’, and ‘A4’) is indicative of a new transaction being initiated based on message processing. Although not shown, each of the message nodes 402-414 may be associated with the same user ID, which indicates that the message nodes 402-414 are associated with the same user.

The graph 400 may enable optimized query processing. For example, the processing circuitry 104 may receive a query indicative of a set of time-series computation functions to be performed for the message trail starting from the first command message. For such an analysis, all the messages correlated to the first command message may be required. In such an embodiment, the processing circuitry 104 may be configured to identify the message nodes 404-414 that are correlated to the message node 402 based on the root correlation ID ‘A0’ and execute the set of time-series computation functions based on the message nodes 402-414. The association of the common correlation ID results in optimized tracking of the correlated message nodes.

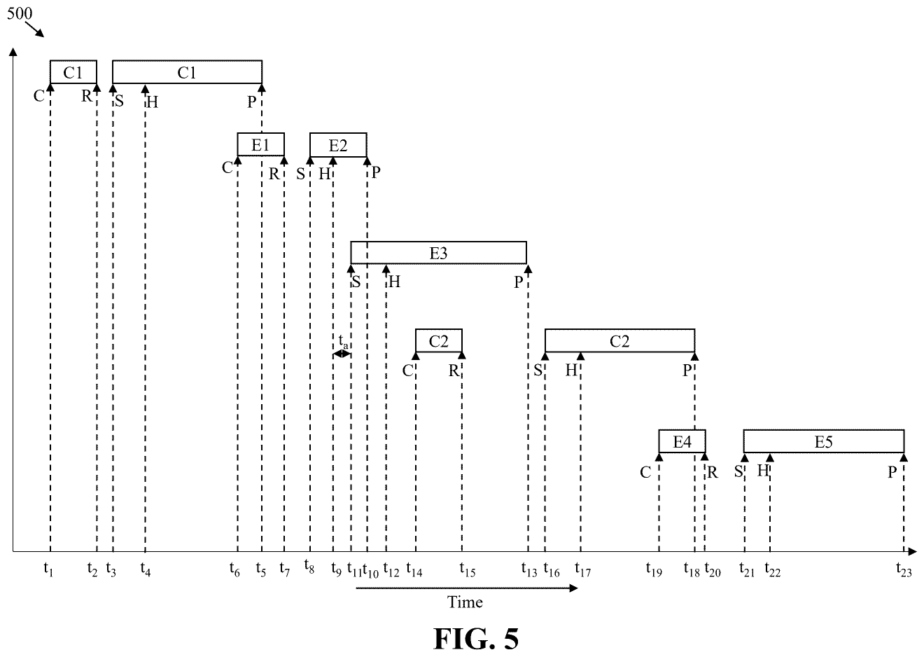

FIG. 5 is a time-sequence diagram 500 that illustrates a sequence in which the milestones associated with the correlated messages of FIG. 4 are achieved, consistent with disclosed embodiments of the present disclosure. Referring to FIG. 5, a horizontal line ‘Time’ shows time-instances at which one or more milestones associated with each of the correlated messages are achieved (e.g., completed). It will be apparent to a person skilled in the art that the rectangular boxes shown herein collectively represent the correlated messages described in conjunction with FIG. 4.

At time instance t₁, the milestone creation event (denoted as “C” in FIG. 5) is achieved by the first command message (denoted as “C1” in FIG. 5). The milestone creation event refers to the creation of the first command message by a microservice associated with the real-time system 102. The time instance t₁ is determined by the processing circuitry 104 as a timestamp associated with the milestone creation event. Also, the timestamp associated with the milestone creation event is determined as a data value for the attribute created-on timestamp associated with the message node 402.

At time instance t₂, another milestone raise event (denoted as “R” in FIG. 5) is achieved by the first command message. The milestone raise event refers to placing/loading the first command message on a message bus (for example, the messaging bus shown in FIG. 10) for being subscribed to by one or more microservices associated with the real-time system 102. The time instance t₂ is determined by the processing circuitry 104 as a timestamp associated with the milestone raise event. Also, the timestamp associated with the milestone raise event is determined as a data value for the attribute raised-on timestamp associated with the message node 402. As mentioned in conjunction with FIG. 4, the first command message is processed during the first transaction. The creation event and the raise event of the first command message take place within a first processing thread of the first transaction. Once the first command message achieves the milestone raise event, a second processing thread is initiated for further execution of the first command message. That is to say that the subscribe event, the handle event, and the process event of the first command message occur within the second processing thread of the first transaction.

At time instance t₃, another milestone subscription event (denoted as “S” in FIG. 5) is achieved by the first command message. The milestone subscription event refers to the subscription of the first command message by a microservice associated with the real-time system 102. The first command message, being a command message, is subscribed by a single microservice. The time instance t₃ is determined by the processing circuitry 104 as a timestamp associated with the milestone subscription event. Also, the timestamp associated with the milestone subscription event is determined as a data value for the attribute subscribed-on timestamp associated with the message node 402. Notably, a time interval between the time instances t₂ and t₃ indicates a time duration for which the first command message is waiting on the message bus to be subscribed. In some embodiments, such time duration may be predefined while in other embodiments, such time duration may be determined based on the availability of microservices or other resources required for processing of the first command message.

At time instance t₄, another milestone handle event (denoted as “H” in FIG. 5) is achieved by the first command message. The milestone handle event refers to the reception of the first command message by the microservice. Notably, the first command message is handled by a single microservice. The time instance t₄ is determined by the processing circuitry 104 as a timestamp associated with the milestone handled event. Also, the timestamp associated with the milestone handled event is determined as a data value for the attribute handled-on timestamp associated with the message node 402. Further, the first command message may be, immediately or after some time, queued for processing. As the microservice can perform only a single transaction at a time, the first command message may be queued.

At time instance t₅, another milestone process event (denoted as “P” in FIG. 5) is achieved by the first command message. The milestone process event refers to the completion of execution/processing of the first command message by the microservice. The time instance t₅ is determined by the processing circuitry 104 as a timestamp associated with the milestone process event. Also, the timestamp associated with the milestone process event is determined as a data value for the attribute processed-on timestamp associated with the message node 402.

Notably, each command message (e.g., the first command message C1) results in the creation of an event message in response to the execution of a corresponding operation. Thus, the creation of the event message is operationally connected to the processing of the command message. That is to say that the event message is created by a transaction associated with the processing of the command message. Hence, the event message is created after the completion of the handle event and before the completion of the process event of the command message. That is to say that the event message is created after the handling of the command message and prior to the completion of processing of the command message. In other words, the first event message (denoted as “E1” in FIG. 5) is created between time instances t₄ and t₅.

At time instance t₆, the first event message is created. The time instance t₆ occurs prior to the time instance t₅ and after the time instance t₄. At time instance t₇, the first event message is raised. The time instance t₇ occurs after the time instance t₆. Further, communication of the first event message is performed in an asynchronous manner. That is to say that the first event message is communicated to its destination microservice via one or more intermediate microservices that form a communication route/channel for its communication. This is reflected as the first event message is raised after the processing of the first command message is completed at the time instance t₅. Such occurrence of the milestone raise event associated with the first event message indicates that the first event message is raised by a transaction that is different from the transaction that leads to the creation of the first command message. Such occurrence of the milestone raise event associated with the first event message may also be due to a smaller number of active transactions, waiting time in the queue at the corresponding microservice, or the like.

Subsequently, the first event message is subscribed to by one or more microservices. As mentioned in conjunction with FIG. 4, the first event message is subscribed to by two microservices. Hence, two clone messages, e.g., the second and third event messages (denoted as “E2” and “E3” in FIG. 5, respectively) are created. Hence, the first event message becomes a header message and the second and third event messages become handled event messages. Notably, the second and third event messages are created only after the first event message is raised. As mentioned throughout the description, for each subscriber (e.g., a microservice) an event header message is published (raised) on a subscriber channel that corresponds to the subscriber microservice. Further, while subscribing to the event header message, a clone of the event header message may be created by the subscriber microservice.

At time instance t₈, the first event message is subscribed by a microservice. That is to say that the second event message is subscribed by the microservice at the time instance t₈. Subsequently, at time instance t₉, the second event message is handled. At time instance t₁₀, the second event message is processed and terminated. That is to say that the second transaction associated with the second event message is terminated.

At time instance t₁₁, the first event message is subscribed by another microservice. That is to say that the third event message is subscribed by another microservice at time instance t₁₁. The time instance t₁₁ occurs after the time instance t₈, which indicates that the second event message and the third event message are subscribed as part of two different transactions. A time interval tₐ between the handle event and the subscribe event of the first event message indicates the subscription of the first event message based on availability as well as the allocation of resources. That is to say that a gap, time interval tₐ, between the handle event and the subscribe event of the first event message indicates that the first event message waits to get subscribed either due to unavailability of resources or due to resources being not allocated. Such a wait-time ensures that the asynchronous communication provides maximum resiliency and throughput while corresponding microservice only takes up tasks that are within its processing capability. At time instance t₁₂, the third event message is handled. At time instance t₁₃, the third event message is processed.

Further, based on the handling of the third event message at the time instance t₁₂, the second command message (denoted as “C2” in FIG. 5) is created at time instance t₁₄. The creation of the second command message based on the handling of the third event message is performed in a manner that is similar to the creation of the first event message based on the handling of the first command message.

Further, raising (namely, publishing) the second command message is performed in a synchronous manner. That is to say that the second command message is published directly from its publisher microservice to a subscriber channel of its destination (e.g., a microservice) without involving any intermediate microservice. This is reflected in FIG. 5 as the second command message is raised at time instance t₁₅ which is prior to a time instance t₁₃ when the third event message is processed. Such occurrence of the milestone raise event associated with the second command message indicates the creation thereof within the third transaction that is associated with the third event message. Therefore, the milestone process event associated with the third event message may not occur prior to the milestone raise event associated with the second command message. Further, the second command message is subscribed, handled, and processed at time instances t₁₆, t₁₇, and t₁₈, respectively.

Based on the handling of the second command message, the fourth event message (denoted as “E4” in FIG. 5) is created. It will be apparent to a person skilled in the art that the creation of the fourth event message based on the handling of the second command message is performed in a manner that is similar to the creation of the first event message based on the handling of the first command message. As shown, the fourth event message is created and raised at time instances t₁₉, and t₂₀, respectively. Further, the fourth event message is subscribed to by a microservice. Hence, a clone message, such as the fifth event message (denoted as “E5” in FIG. 5) is created. The fifth event message is subscribed at time instance t₂₁. Subsequently, the fifth event message is handled and processed at time instances t₂₂ and t₂₃, respectively.

It will be apparent to a person skilled in the art that various timestamps associated with the second command message and the first through fifth event messages are determined in a manner that is similar to the first command message.

It will be apparent to a person skilled in the art that the milestones shown in FIG. 5 are exemplary and do not limit the scope of the disclosure. In other embodiments, each message may have additional or different milestones.

In FIG. 4, the correlated message nodes 402-414 are illustrated in the compact form. That is to say that compositions associated therewith are not shown in FIG. 4. While executing the time-series computation functions on any message node, message compositions may be required, and hence, it is important to understand the structure of the compositions of correlated messages in the directed property graph 110.

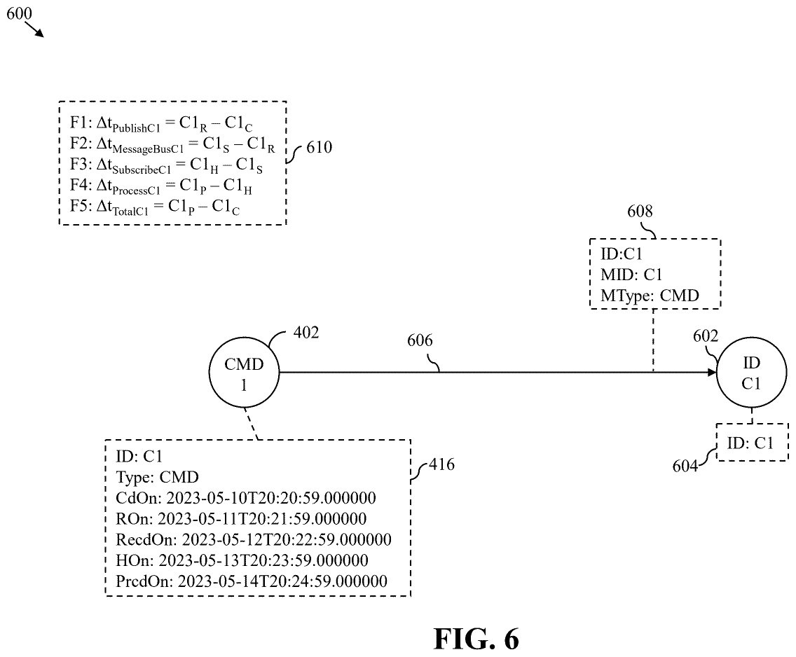

FIG. 6 is a graph 600 illustrating time-series computation using a single message node, consistent with disclosed embodiments of the present disclosure. The graph 600 may correspond to a portion of the directed property graph 110. As shown in FIG. 6, the composition of the message node 402 is illustrated.

The processing circuitry 104 may be configured to instantiate the message node 402 representing the first command message. The first command message may have a plurality of attributes associated therewith. The processing circuitry 104 may be further configured to associate a first set of attributes as node properties of the message node 402. The node properties of the message node 402 are shown within the dotted box 416 associated with the message node 402. The dotted box 416 is shown to include some of the attributes in the form of key-value pairs such as ID: ‘C1’, message type: ‘Command’ (denoted as ‘CMD’ in FIG. 6), CdOn: ‘2023-05-10T20:20:59.000000’,ROn: ‘2023-05-11T20:21:59.000000’, RecdOn: ‘2023-05-12T20:22:59.000000’, HOn: ‘2023-05-13T20:23:59.000000’, and PrcdOn: ‘2023-05-14T20:24:59.000000’.
The processing circuitry 104 may be configured to derive a second set of attributes for the message node 402. The second set of attributes is shared with at least one other message.
For the sake of simplicity, ID is assumed to be the shared attribute. The processing circuitry 104 may be further configured to instantiate attribute node 602 representing the ID associated with the first command message.

The attribute node 602 may represent the ID of the message node 402. Thus, the attribute node 602 may store a data value ‘C1’. Further, some attributes may be associated as node properties of the attribute node 602 in the same manner as described above in FIG. 3. The node properties of the attribute node 602 are illustrated in a dotted box 604. The dotted box 604 is shown to include some of the attributes in the form of key-value pairs such as ID: ‘C1’. The processing circuitry 104 may be configured to create an edge 606 between the message node 402 and the attribute node 602. Some attributes may be associated as the edge properties of the edge 606 in the same manner as described above in FIG. 3. The edge properties of the edge 606 are illustrated in a dotted box 608, respectively. The dotted box 608 is shown to include the attributes of the edge 606 in the form of key-value pairs such as ID: ‘C1’, message ID: ‘C1’, and message type: ‘CMD’.

The graph 600 illustrated in FIG. 6 describes the composition of one message node. The structure of the graph 600, especially having some attributes as nodes, enables optimized query processing and efficient execution of time-series computations. In an example, the processing circuitry 104 may receive a query 610 that is indicative of a set of time-series computation functions to be executed in the graph 600. The set of time-series computation functions may include:

Δt_{PublishC1}=C1_{R}−C1_{C} F1

Δt_{MessageBusC1}=C1_{S}−C1_{R} F2

Δt_{SubscribeC1}=C1_{H}−C1_{S} F3

Δt_{ProcessC1}=C1_{P}−C1_{H} F4

Δt_{TotalC1}=C1_{P}−C1_{C} F5
where,
C1_{R} is the time instance of raising of the first command message,
C1_{C} is the time instance of creation of the first command message,
Δt_{PublishC1} is the time required for the publication of the first command message,
C1_{S} is the time instance of subscription of the first command message,
Δt_{MessageBusC1} is the time spent by the first command message on the message bus,
C1_{H} is the time instance of handling of the first command message,
Δt_{SubscribeC1} is the time interval for which the first command message was idle after being subscribed,
C1_{P} is the time instance of completion of processing of the first command message,
Δt_{ProcessC1} is the time interval required for processing of the first command message, and
Δt_{TotalC1} is the time interval required for communication and processing of the first command message.

To execute the query, the processing circuitry 104 may identify, in the directed property graph 110, the attribute node comprising the data value ‘C1’ (for example, the attribute node 602). Further, the processing circuitry 104 may identify the edge (e.g., the edge 606) associated with the attribute node 602. Based on the edge properties of the edge 606 and the node properties of the attribute node 602, the processing circuitry 104 may identify the first command message represented by the message node 402. That is to say, the processing circuitry 104 may determine the message node 402. Further, the processing circuitry 104 may identify, from the node properties of the message node 402, attributes required to execute the time-series computation functions F1-F5. The attributes required to execute the time-series computation function F1 are the created-on and raised-on timestamps, whereas the attributes required to execute the time-series computation function F2 are the raised-on and subscribed-on timestamps. Further, the attributes required to execute the time-series computation function F3 are the subscribed-on and handled-on timestamps, whereas the attributes required to execute the time-series computation function F4 are the handled-on and processed-on timestamps. Lastly, the attributes required to execute the time-series computation function F5 are the created-on and processed-on timestamps. Thus, the attributes required to execute the time-series computation functions F1-F5 are the created-on timestamp, the raised-on timestamp, the subscribed-on timestamp, the handled-on timestamp, and the processed-on timestamp of the first command message. Thus, the processing circuitry 104 may identify the data values associated with the created-on timestamp, the raised-on timestamp, the subscribed-on timestamp, the handled-on timestamp, and the processed-on timestamp of the first command message. The processing circuitry 104 may be further configured to execute the time-series computation functions F1-F5 based on the identified attributes (e.g., the identified data values).

The time-series computation using other message nodes may be implemented in a similar manner as described above.

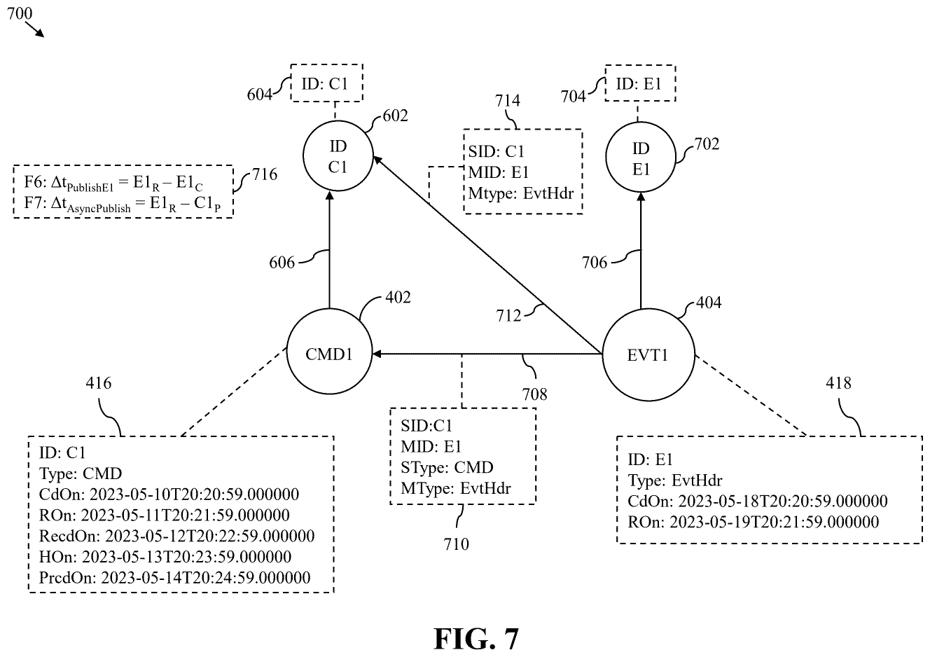

FIG. 7 is a graph 700 illustrating time-series computation using multiple message nodes, consistent with disclosed embodiments of the present disclosure. The graph 700 may correspond to a portion of the directed property graph 110.

The processing circuitry 104 may be configured to instantiate the message nodes 402 and 404 representing the first command message and the first event message, respectively, and associate some attributes as node properties thereof. The node properties of the message nodes 402 and 404 are shown within the dotted boxes 416 and 418, respectively. The dotted box 416 is shown to include some of the attributes of the message node 402 in the form of key-value pairs such as ID: ‘C1’, message type: ‘Command’, CdOn: ‘2023-05-10T20:20:59.000000’, ROn: ‘2023-05-11T20:21:59.000000’, RecdOn: ‘2023-05-12T20:22:59.000000’, HOn: ‘2023-05-13T20:23:59.000000’, and PrcdOn: ‘2023-05-14T20:24:59.000000’. The dotted box 418 is shown to include some of the attributes of the message node 404 in the form of key-value pairs such as ID: ‘E1’, message type: ‘EventHeader’ (denoted as ‘EvtHdr’ in FIG. 7), CdOn: ‘2023-05-18T20:20:59.000000’, and ROn: ‘2023-05-19T20:21:59.000000’.

The processing circuitry 104 may be configured to instantiate the attribute node 602 and an attribute node 702 representing the IDs of the first command message and the first event message, respectively. Further, some attributes may be associated as node properties of the attribute nodes 602 and 702 in the same manner as described above in FIG. 3. The node properties of the attribute nodes 602 and 702 are illustrated in the dotted box 604 and a dotted box 704, respectively. The dotted box 604 is shown to include some of the attributes in the form of key-value pairs such as ID: ‘C1’. The dotted box 704 is shown to include some of the attributes in the form of key-value pairs such as ID: ‘E1’.

The processing circuitry 104 may be configured to create the edge 606 between the message node 402 and the attribute node 602, and an edge 706 between the message node 404 and the attribute node 702. Some attributes may be associated as edge properties of the edges 606 and 706 in the same manner as described above in FIG. 6, and are not shown in FIG. 7 to keep the illustrations concise and clear.

As explained in FIG. 4, the processing of the first command message leads to the generation of the first event message. Therefore, the first command message corresponds to a source message of the first event message. Consequently, the message node 402 corresponds to a source message node of the message node 404. Thus, the processing circuitry 104 may be further configured to create an edge 708 between the message nodes 402 and 404, determine a set of edge attributes for the edge 708 that is indicative of a causal association between the message nodes 402 and 404, and associate the determined set of edge attributes as edge properties of the edge 708. The determined set of edge attributes may include at least one attribute associated as the node properties of the message node 402 and at least one attribute associated as the node properties of the message node 404. The edge properties of the edge 708 is illustrated in a dotted box 710. The dotted box 710 is shown to include some of the edge attributes in the form of key-value pair such as source ID: ‘C1’, message ID: ‘E1’, source (denoted as “SType”): ‘CMD’, and MType: ‘EvtHdr’.

Additionally, the ID ‘C1’ associated with the first command message may correspond to a source ID for the first event message. Thus, the data value associated with the attribute node 602 may be shared between the message nodes 402 and 404. The processing circuitry 104 may thus be configured to create an edge 712 between the message node 404 and the attribute node 602, determine a set of edge attributes for the edge 712 that is indicative of an association between the message node 404 and the attribute node 602, and associate the determined set of edge attributes as edge properties of the edge 712. The determined set of edge attributes may include at least one attribute associated as the node properties of the attribute node 602 and at least one attribute associated as the node properties of the message node 404. The edge properties of the edge 712 is illustrated in a dotted box 714. The dotted box 714 is shown to include some of the edge attributes in the form of key-value pairs such as source ID: ‘C1’, message ID: ‘E1’, and Mtype: ‘EvtHdr’.

The graph 700 illustrated in FIG. 7 describes the compositions of message nodes 402 and 404. The structure of the graph 700, especially the sharing of attribute nodes and edges between message nodes, enables optimized query processing and efficient execution of time-series computations. In an example, the processing circuitry 104 may receive a query 716 that is indicative of a set of time-series computation functions to be executed in the graph 700. The set of time-series computation functions may include:

Δt_{PublishE1}=E1_{R}−E1_{C} F6

Δt_{AsyncPublish}=E1_{R}−C1_{P} F∂
where,
E1_{R} is the time instance of raising of the first event message,
E1_{C} is the time instance of creation of the first event message,
Δt_{PublishE1} is the time required for publication of the first event message,
C1_{P} is the time instance of completion of processing of the first command message,
Δt_{AsyncPublish} is the time required for the publication of the first event message when communicated in the asynchronous manner.

To execute the query, the processing circuitry 104 may identify, in the directed property graph 110, the attribute node comprising the data value ‘E1’ (for example, the attribute node 702). Further, the processing circuitry 104 may identify the edge (e.g., the edge 706) associated with the attribute node 702. Based on the edge properties of the edge 706 and the node properties of the attribute node 702, the processing circuitry 104 may identify the first event message represented by the message node 404. That is to say, the processing circuitry 104 may determine the message node 404. As the first event message is generated based on the processing of the first command message, a timestamp marking the completion of processing for the first command message may be required for the execution of the set of time-series computation functions. Therefore, the processing circuitry 104 may be further configured to identify the edge 708 associated with the message node 404. Based on the edge properties of the edge 708, the processing circuitry 104 may be configured to determine the message node 402 representing the first command message.

The processing circuitry 104 may be configured to identify, from the node properties of the message nodes 402 and 404, attributes required to execute the time-series computation functions F6 and F7. The attributes required to execute the time-series computation function F6 are the created-on and raised-on timestamps of the first event message and the attributes required to execute the time-series computation function F7 are the raised-on timestamp of the first event message and the processed-on timestamp of the first command message. Thus, the attributes required to execute the time-series computation functions F6 and F7 are the created-on and raised-on timestamps of the first event message, and the processed-on timestamp of the first command message. The processing circuitry 104 may identify the data values associated with the created-and raised-on timestamps of the first event message, and the processed-on timestamp of the first command message. The data values associated with the created-on timestamp and the raised-on timestamp of the first event message may be identified from the node properties of the message node 404, and the data value associated with the processed-on timestamp of the first command message may be identified from the node properties of the message node 402. Further, the processing circuitry 104 may be configured to execute the time-series computation functions F6 and F7 based on the identified attributes (e.g., the identified data values).

In the aforementioned example, if all the attributes of the first event message were associated as node properties, node properties of each message node in the directed property graph 110 would have to be searched to identify the value ‘E1’. Such a query would be expensive. Alternatively, instantiating all the attributes as attribute nodes may be costly in terms of memory utilization. The solution of the present disclosure, that involves having limited attributes (e.g., the data value ‘E1’) as the attribute nodes, ensures that the memory utilization is less as well as the query processing is optimized. Additionally, the edge 708 allows faster identification of the message node 402 as the processing circuitry 104 would have otherwise required to explicitly search for the command message node 402 by searching in the node properties of each message node in the directed property graph 110.

The scope of the present disclosure is not limited to the query processing as described above. In several embodiments, to execute the query, the processing circuitry 104 may identify, in the directed property graph 110, the attribute node comprising the data value ‘C1’ (for example, the attribute node 602). Further, the processing circuitry 104 may identify the edges associated with the attribute node 602 (e.g., the edges 606 and 712). Based on the edge properties of the edges 606 and 712 and the node properties of the attribute node 602, the processing circuitry 104 may identify the first command message represented by the message node 402 and the first event message represented by the message node 404. That is to say, the processing circuitry 104 may determine the message nodes 402 and 404. Thus, as the attribute node 602 is associated with two message nodes (e.g., the message nodes 402 and 404), the processing circuitry 104 may determine the message nodes 402 and 404 based on the attribute node 602.

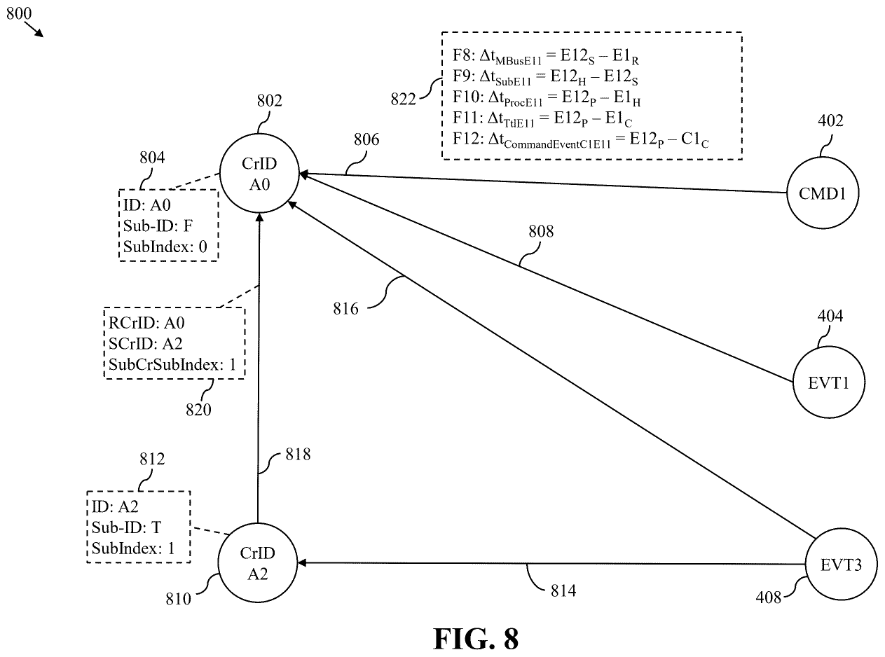

FIG. 8 is a graph 800 illustrating another time-series computation using multiple message nodes, consistent with disclosed embodiments of the present disclosure. The graph 800 may correspond to a portion of the directed property graph 110. For the sake of simplicity, FIG. 8 illustrates exclusively the message nodes 402-406, the compositions thereof, and the correlation therebetween. However, other correlated message nodes may be implemented in a similar manner.

The processing circuitry 104 may be configured to instantiate the message nodes 402, 404, and 408 representing the first command message, the first event message, and the third event message, respectively. Some attributes may be associated as node properties of the message nodes 402, 404, and 408 in the same manner as described above in FIGS. 3, 4, 6, and 7, and are not shown in FIG. 8 to keep the illustrations concise and clear.

The processing circuitry 104 may be configured to instantiate the attribute node 802 representing the correlation ID of the message node 402. The attribute node 802 may store a data value ‘A0’ indicative of the correlation ID of the first command message. The processing circuitry 104 may be configured to determine a set of attributes for the attribute node 802 and associate the determined set of attributes as node properties of the attribute node 802. The determined set of attributes may be linked with the shared attribute (e.g., the correlation ID) represented by the attribute node 802. The node properties of the attribute node 802 are illustrated in a dotted box 804. The dotted box 804 is shown to include some of the attributes in the form of key-value pairs such as ID: ‘A0’, sub-ID: ‘F’, and sub-index: ‘0’.

The processing circuitry 104 may be configured to create an edge 806 between the message node 402 and the attribute node 802. As explained in FIG. 4, the first event message has the same correlation ID as the first command message. Thus, the processing circuitry 104 may be configured to create an edge 808 between the message node 404 (that represents the first event message) and the attribute node 802. Some attributes may be associated as edge properties of the edges 806 and 808 in the same manner as described above in FIGS. 3 and 6, and are not shown in FIG. 8 to keep the illustrations concise and clear.

When the third event message is generated based on the processing of the first event message, the transaction changes. Thus, the third event message may have an additional correlation ID (e.g., the sub-correlation ID). The processing circuitry 104 may be configured to instantiate an attribute node 810 that may represent the correlation ID ‘A2’. Some attributes may be associated as node properties of the attribute node 810 in the same manner as described above for the attribute node 802. The node properties of the attribute node 810 are illustrated in a dotted box 812. The dotted box 812 is shown to include attributes in the form of key-value pairs such as ID: ‘A2’, sub-ID: ‘True’ (denoted as ‘T’ in FIG. 8), and sub-index: ‘1’.

The processing circuitry 104 may be configured to create an edge 814 between the message node 408 and the attribute node 810. As the correlation ID ‘A0’ corresponds to the root correlation ID for the third event message, the processing circuitry 104 may be configured to create an edge 816 between the message node 408 (that represents the second third message) and the attribute node 802. Some attributes may be associated as edge properties of the edges 814 and 816 in the same manner as described above in FIGS. 3 and 6, and are not shown in FIG. 8 to keep the illustrations concise and clear.

In the present disclosure, the directed property graph 110 may include various edges coupling attribute nodes. In other words, one edge may couple two attribute nodes. Thus, the processing circuitry 104 may be further configured to create an edge 818 between the attribute nodes 802 and 810. The edge 818 may have various edge attributes associated as edge properties thereof, the edge attributes being indicative of an association between the two attribute nodes 802 and 810. The edge properties of the edge 818 may include at least one attribute associated as the node properties of the attribute node 802 and at least one attribute associated as the node properties of the attribute node 810. The edge properties of the edge 818 is illustrated in a dotted box 820. The dotted box 820 is shown to include some of the attributes in the form of key-value pairs such as root correlation ID (denoted as “RCrID” in FIG. 8): ‘A0’, sub correlation ID (denoted as “SCrID” in FIG. 8): ‘A2’, and sub correlation sub-index (denoted as “SubCrSubIndex” in FIG. 8): ‘1’. The sub correlation sub-index ‘1’ indicates that the correlation ID ‘A0’ is the root correlation ID and the correlation ID ‘A2’ is at the first level of hierarchy within the first transaction.

Although not shown, the graph 800 may further include other attribute nodes representing different correlation IDs, with edges coupling each attribute node to a previous attribute node (e.g., a previous correlation ID), any intermediate attribute nodes, or the root attribute node (e.g., the attribute node 802 representing the root correlation ID).

The graph 800 illustrated in FIG. 8 describes the compositions of message nodes 402, 404, and 408. The structure of the graph 800, especially the sharing of attribute nodes, edges between message nodes, and edges between attribute nodes, enables optimized query processing and efficient execution of time-series computation. In an example, the processing circuitry 104 may receive a query 822 that is indicative of a set of time-series computation functions to be executed in the graph 800. The set of time-series computation functions may include:

Δt_{MBusE12}=E12_{S}−E2_{R} F8

Δt_{SubE12}=E12_{H}−E12_{S} F9

Δt_{ProcE12}=E12_{P}−E1_{H} F10

Δt_{TtlE12}=E12_{P}−E1_{C} F11

Δt_{CommandEventC1E12}=E12_{P}−C1_{C} F12
where,
E1_{R} is the time instance of raising of the first event message,
E12_{S} is the time instance of subscription of the third event message,
Δt_{MBusE12} is the time period for which the third event message was idle on the message bus before getting subscribed,
E12_{H} is the time instance of handling of the third event message,
Δt_{SubE12} is the time period for which the third event message was subscribed but not handled,
E1_{H} is the time instance of handling of the first event message,
E12_{P} is the time instance of completion of processing of the third event message,
Δt_{ProcE12} is the time period required for processing the third event message,
Δt_{TtlE12} is the total time period required for communication and processing of the third event message,
C1_{C} is the time instance of creation of the first command message, and
Δt_{CommandEventC1E12} is the time period required for creation of the first command message and processing of the third event message based on the first transaction associated with the first command message.

To execute the query, the processing circuitry 104 may identify, in the directed property graph 110, the attribute node comprising the data value ‘A2’ (for example, the attribute node 810). Further, the processing circuitry 104 may identify the edge 814 associated with the attribute node 810. Based on the edge properties of the edge 814 and the node properties of the attribute node 810, the processing circuitry 104 may identify the third event message represented by the message node 408. That is to say, the processing circuitry 104 may determine the message node 408. As the third event message is generated based on the processing of the first event message, and the first event message is generated based on the processing of the first command message, the timestamp marking the creation of the first command message, the raising of the first event message, and handling of the first event message may be required for the execution of the set of time-series computation functions.

Based on the node properties of the attribute node 810, the processing circuitry 104 may determine that the correlation ID ‘A2’ is not the root correlation ID. Further, the processing circuitry 104 may identify the edge 818 linking the attribute node 810 to the attribute node 802 (e.g., the root correlation ID) and identify the attribute node 802 based on the identified edge 818 and the edge properties of the edge 818. Further, the processing circuitry 104 may identify the edges 806 and 808 associated with the attribute node 802. Based on the edge properties of the edges 806 and 808 and the node properties of the attribute node 802, the processing circuitry 104 may identify the first command message and the first event message represented by the message nodes 402 and 404, respectively. That is to say, the processing circuitry 104 may determine the message nodes 402 and 404 based on the attribute node 802.

The processing circuitry 104 may be configured to identify, from the node properties of the message nodes 402, 404, and 408, attributes required to execute the time-series computation functions F8-F12. The attributes required to execute the time-series computation function F8 are the raised-on timestamp of the first event message and the subscribed-on timestamp of the third event message, whereas the attributes required to execute the time-series computation function F9 are the subscribed-on and handled-on timestamps of the third event message. Similarly, the attributes required to execute the time-series computation function F10 are the handled-on timestamp of the first event message and the processed-on timestamp of the third event message, whereas the attributes required to execute the time-series computation function F11 are the created-on timestamp of the first event message and the processed-on timestamp of the third event message. Similarly, the attributes required to execute the time-series computation function F12 are the created-on timestamp of the first command message and the processed-on timestamp of the third event message. Thus, the attributes required to execute the time-series computation functions F8-F12 are the created-on timestamp of the first command message, the created-on, raised-on, and handled-on timestamps of the first event message, and the subscribed-on, handled-on, and processed-on timestamps of the third event message.

The processing circuitry 104 may identify the data values associated with the created-on timestamp of the first command message, the created-on, raised-on, and handled-on timestamps of the first event message, and the subscribed-on, handled-on, and processed-on timestamps of the third event message. The data values associated with the created-on timestamp of the first command message may be identified from the node properties of the message node 402. Similarly, the data values associated with the created-on, raised-on, and handled-on timestamps of the first event message may be identified from the node properties of the message node 404. Further, the data values associated with the subscribed-on, handled-on, and processed-on timestamps of the third event message may be identified from the node properties of the message node 408. Further, the processing circuitry 104 may be configured to execute the time-series computation functions F8-F12 based on the identified attributes (e.g., the identified data values).

The scope of the present disclosure is not limited to the query processing as described above. In several embodiments, to execute the query, the processing circuitry 104 may identify, in the directed property graph 110, the attribute node 802 comprising the data value ‘A0’. Further, the processing circuitry 104 may identify the edges 806, 808, and 816 associated with the attribute node 802. Based on the edge properties of the edges 806, 808, and 816 and the node properties of the attribute node 802, the processing circuitry 104 may identify the first command message represented by the message node 402, the first event message represented by the message node 404, and the third event message represented by the message node 408. That is to say, the processing circuitry 104 may determine the message nodes 402, 404, and 408. Thus, as the attribute node 802 is associated with three message nodes (e.g., the message nodes 402, 404, and 408), the processing circuitry 104 may determine the message nodes 402, 404, and 408 based on the attribute node 802.

FIGS. 6-8 illustrate various time-series computation functions executed for various messages. The scope of the present disclosure is not limited to the time-series computation functions described in FIGS. 6-8. Different time-series computation functions associated with different messages may be executed using the directed property graph 110, without deviating from the scope of the present disclosure.

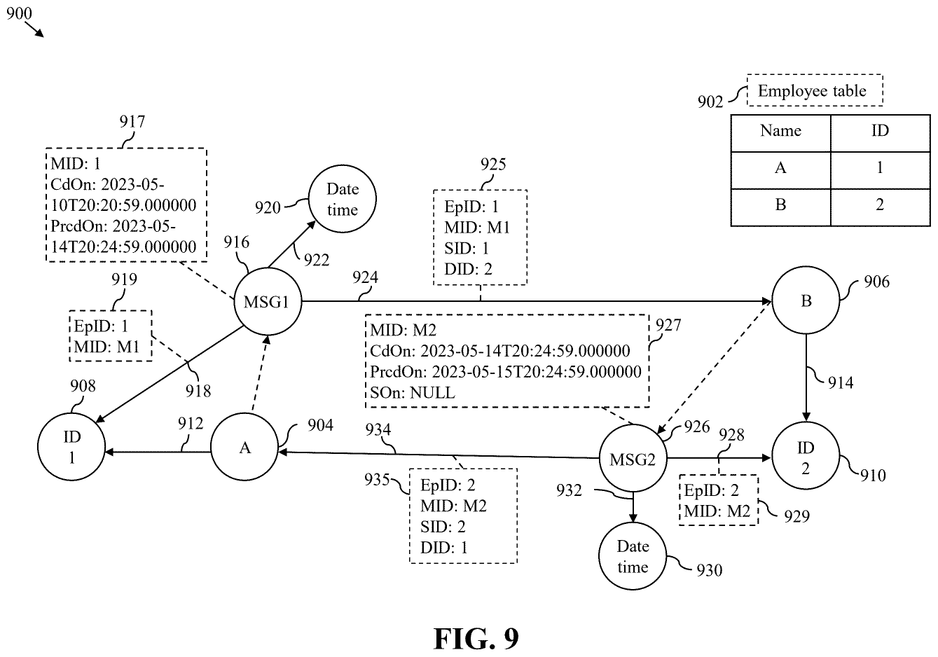

FIG. 9 is a schematic diagram that illustrates an example implementation of time-series message management in a graph 900, consistent with disclosed embodiments of the present disclosure. Referring to FIG. 9, the graph 900 may be derived from an employee table 902 and showcases communication between two employees that may be associated with an organization. These employees may be working on a project that requires ongoing communication between them. The employee table 902 is shown to include two columns: name and ID. The name column stores the names of the employees associated with the organization, for example, employee A and employee B. The ID column stores unique IDs of the employees, for example, ID ‘1’ for employee A and ID ‘2’ for employee B.

The employee A is represented as an employee node 904 and the employee B is represented as an employee node 906. Further, an attribute node 908 may represent the ID of employee A, and an attribute node 910 may represent the ID of employee B. The employee node 904 is associated with the attribute node 908 by way of an edge 912. Although not shown, the edge 912 has edge properties associated therewith. The edge properties may be in the form of key-value pairs such as name: ‘A’ and ID: ‘1’. Similarly, the employee node 906 is associated with the attribute node 910 by way of an edge 914. Although not shown, the edge 914 has edge properties associated therewith. The edge properties may be in the form of key-value pairs such as name: ‘B’ and ID: ‘2’.

The project may be initiated by the employee A. Upon execution of a certain portion of the project, the employee A may communicate with the employee B for further execution of the project. In such a scenario, the employee A may send a first message to the employee B. The first message is represented by a message node 916. The first message is associated with an ID ‘M1’. The message node 916 is shown to be associated with a dotted box 917 that may represent node properties thereof. The dotted box 917 is shown to include some of the attributes in the form of key-value pairs such as message ID: ‘M1’, created-on timestamp: ‘2023-05-10T20:20:59.000000’, and processed-on timestamp: ‘2023-05-14T20:20:59.000000’. The association between the employee node 904 and the message node 916 is shown by a dotted arrow.

The first message is created by the employee A. Therefore, the ID of the employee A may correspond to a source ID of the first message. An edge 918 is shown to couple the message node 916 with the attribute node 908 i.e., the ID of the employee A. The edge 918 is shown to be associated with a dotted box 919 that may include some of the edge properties in the form of key-value pair such as employee ID (denoted as “EpID” in FIG. 9): ‘1’, message ID (denoted as “MID” in FIG. 9): ‘M1’. Further, the message node 916 is shown to be associated with an attribute node 920 that may represent a creation timestamp of the first message. The message node 916 is shown to be coupled to the attribute node 920 by way of an edge 922. Although not shown, the edge 922 may have edge properties associated therewith.

The first message may include the ID of the employee B, and hence, may be directly communicated to employee B. The message node 916 is shown to be associated with the employee node 906 by way of an edge 924. The edge 924 is shown to be associated with a dotted box 925 that may include edge properties of the edge 924. As shown, the dotted box 925 may include some of the edge attributes such as the employee ID associated with the first message, i.e., EID: ‘1’, message ID of the first message, i.e., MID: ‘M1’, source ID of the first message, i.e., source ID (denoted as “SID” in FIG. 9): ‘1’, and destination ID (denoted as “DID” in FIG. 9) of the first message, i.e., DID: ‘2’. Further, upon reception of the first message, the employee B may send an acknowledgment message (not shown) of the successful reception of the first message to employee A.

Further, the first message may be processed by the employee B. In response to the processing of the first message, the employee B may generate a second message. Further, the employee B may send the second message to the employee A. The second message is represented as a message node 926. The second message is associated with an ID ‘M2’. The message node 926 is shown to be associated with a dotted box 927 that may include properties of the second message. As shown, the dotted box 927 may include the ID of the second message, i.e., MID: ‘M2’, created-on timestamp: ‘2023-05-14T20:24:59.000000’, processed-on timestamp: ‘2023-05-15T20:24:59.000000’, subscribed-on timestamp: ‘NULL’. The association between the employee node 906 and the message node 926 is shown by a dotted arrow.

The second message is created by the employee B. Therefore, the ID of the employee B may correspond to a source ID of the second message. An edge 928 is shown to couple the message node 926 with the attribute node 910. The edge 928 is shown to be associated with a dotted box 929, which may include edge properties in the form of key-value pairs such as EID: ‘2’ and MID: ‘M2’. Further, the message node 926 is shown to be associated with an attribute node 930 that may comprise a created timestamp of the second message. The message node 926 is shown to be coupled to the attribute node 930 by way of an edge 932. Although not shown, the edge 932 may be associated with edge properties.

The second message may include the ID of the employee A, and hence, may be directly communicated to employee A. The message node 926 is shown to be associated with the employee node 904 by way of an edge 934. The edge 934 is shown to be associated with a dotted box 935 that may include edge properties of the edge 934. As shown, the dotted box 935 may include the employee ID associated with the second message, i.e., EID: ‘2’, message ID of the second message, i.e., MID: ‘M2’, source ID of the second message, i.e., SID: ‘2’ and destination ID of the second message, i.e., DID: ‘1’.

Further, the employee B may wait for a specified period of time for employee A to send an acknowledgment message of successful receipt of the second message. However, upon not receiving the acknowledgment message in the threshold time, the employee B may initiate an alert within the organization to escalate the issue for further investigation and resolution.

Upon the alert being initiated by the employee B, the processing circuitry 104 may identify the attribute node 910 associated with the employee B. Further, the processing circuitry 104 may identify the edge 928 associated with the attribute node 910. The processing circuitry 104 may identify, from the edge properties of the edge 928, the second message represented by the message node 926. Further, the processing circuitry 104 may analyze the node properties of the message node 926. The processing circuitry 104 may further identify that the data value for the subscribed-on timestamp is ‘NULL’. The processing circuitry 104 may further derive an analytical insight that the second message may be lost. This analytical insight may be beneficial for the organization to take necessary action for resolution of the anomaly, for example, indicating employee B to re-send the second message. This analytical insight may further indicate whether other messages created at the same time as the second message have also been lost by analyzing the node properties thereof.

The aforementioned architecture may be utilized to derive various analytical insights, such as the total number of messages created in a given time period, the highest number of messages being sent by an employee, or the like. Such analytical insights are crucial in different domains that facilitate real-time or near real-time exchange of information by way of messages.

FIG. 10 illustrates an example computing system 1000 for carrying out the methods of the present disclosure, consistent with disclosed embodiments of the present disclosure. Specifically, FIG. 10 shows a block diagram of an embodiment of the computing system 1000 according to example embodiments of the present disclosure.

The computing system 1000 may be configured to perform any of the operations disclosed herein. The computing system 1000 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 1000 is a distributed system configured to function using multiple computing machines interconnected via a data network or bus system.

The computing system 1000 includes computing devices (such as a computing device 1002). The computing device 1002 includes one or more processors (such as a processor 1004) and a memory 1006. The processor 1004 may be any general-purpose processor(s) configured to execute a set of instructions. For example, the processor 1004 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 1004 may be multiple processing units, a single processing core, multiple processing cores, special purpose processing cores, co-processors, or any combination thereof. The processor 1004 may be communicatively coupled to the memory 1006 via an address bus 1008, a control bus 1010, a data bus 1012, and a messaging bus 1014.

The memory 1006 may include non-volatile memories such as a read-only memory (ROM), a programable read-only memory (PROM), an erasable programmable read-only memory (EPROM), a flash memory, or any other device capable of storing program instructions or data with or without applied power. The memory 1006 may also include volatile memories, such as a random-access memory (RAM), a static random-access memory (SRAM), a dynamic random-access memory (DRAM), and a synchronous dynamic random-access memory (SDRAM). The memory 1006 may include single or multiple memory modules. While the memory 1006 is depicted as part of the computing device 1002, a person skilled in the art will recognize that the memory 1006 can be separate from the computing device 1002.

The memory 1006 may store information that can be accessed by the processor 1004. For instance, the memory 1006 (e.g., one or more non-transitory computer-readable storage mediums, memory devices) may include computer-readable instructions (not shown) that can be executed by the processor 1004. The computer-readable instructions may be software written in any suitable programming language or may be implemented in hardware. Additionally, or alternatively, the computer-readable instructions may be executed in logically and/or virtually separate threads on the processor 1004. For example, the memory 1006 may store instructions (not shown) that when executed by the processor 1004 cause the processor 1004 to perform operations such as any of the operations and functions for which the computing system 1000 is configured, as described herein. Additionally, or alternatively, the memory 1006 may store data (not shown) that can be obtained, received, accessed, written, manipulated, created, and/or stored. The data can include, for instance, the data and/or information described herein in relation to FIGS. 1-9. In some implementations, the computing device 1002 may obtain from and/or store data in one or more memory device(s) that are remote from the computing system 1000.

The computing device 1002 may further include an input/output (I/O) interface 1016 communicatively coupled to the address bus 1008, the control bus 1010, and the data bus 1012. The data bus 1012 and messaging bus 1014 may include a plurality of tunnels that may support parallel processing of messages. The I/O interface 1016 is configured to couple to one or more external devices (e.g., to receive and send data from/to one or more external devices). Such external devices, along with the various internal devices, may also be known as peripheral devices. The I/O interface 1016 may include both electrical and physical connections for operably coupling the various peripheral devices to the computing device 1002. The I/O interface 1016 may be configured to communicate data, addresses, and control signals between the peripheral devices and the computing device 1002. The I/O interface 1016 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 1016 is configured to implement only one interface or bus technology. Alternatively, the I/O interface 1016 is configured to implement multiple interfaces or bus technologies. The I/O interface 1016 may include one or more buffers for buffering transmissions between one or more external devices, internal devices, the computing device 1002, or the processor 1004. The I/O interface 1016 may couple the computing device 1002 to various input devices, including mice, touch screens, scanners, biometric readers, electronic digitizers, sensors, receivers, touchpads, trackballs, cameras, microphones, keyboards, any other pointing devices, or any combinations thereof. The I/O interface 1016 may couple the computing device 1002 to various output devices, including video displays, speakers, printers, projectors, tactile feedback devices, automation control, robotic components, actuators, motors, fans, solenoids, valves, pumps, transmitters, signal emitters, lights, and so forth.

The computing system 1000 may further include a storage unit 1018, a network interface 1020, an input controller 1022, and an output controller 1024. The storage unit 1018, the network interface 1020, the input controller 1022, and the output controller 1024 are communicatively coupled to the central control unit (e.g., the memory 1006, the address bus 1008, the control bus 1010, and the data bus 1012) via the I/O interface 1016. The network interface 1020 communicatively couples the computing system 1000 to one or more networks such as wide area networks (WAN), local area networks (LAN), intranets, the Internet, wireless access networks, wired networks, mobile networks, telephone networks, optical networks, or combinations thereof. The network interface 1020 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 1018 is a computer-readable medium, preferably a non-transitory computer-readable medium, comprising one or more programs, the one or more programs comprising instructions which when executed by the processor 1004 cause the computing system 1000 to perform the method steps of the present disclosure. Alternatively, the storage unit 1018 is a transitory computer-readable medium. The storage unit 1018 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 1018 stores one or more operating systems, application programs, program modules, data, or any other information. The storage unit 1018 is part of the computing device 1002. Alternatively, the storage unit 1018 is part of one or more other computing machines that are in communication with the computing device 1002, such as servers, database servers, cloud storage, network attached storage, and so forth.

The input controller 1022 may include suitable logic, circuitry, interfaces, and/or code, executable by the circuitry, that may be configured to control one or more input devices that may be configured to receive an input (e.g., the query) generated by the real-time system 102. The output controller 1024 may include suitable logic, circuitry, interfaces, and/or code, executable by the circuitry, that may be configured to control one or more output devices that may be configured to render/output the outcome of the operation executed to process the received input.

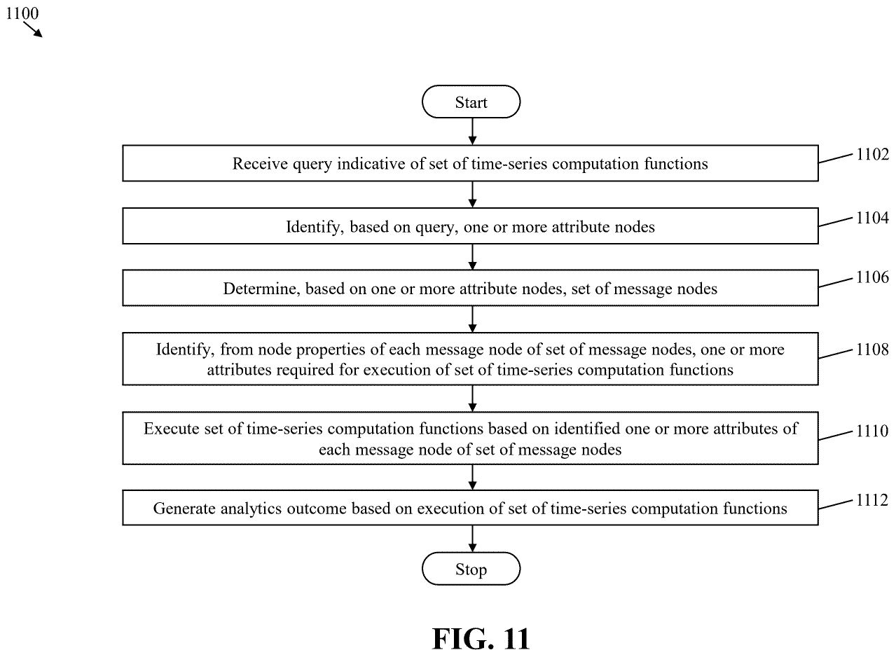

FIG. 11 represents a flowchart 1100 that illustrates a method for facilitating time-series message management using directed property graphs, consistent with disclosed embodiments of the present disclosure.

Referring to FIG. 11, at 1102, the processing circuitry 104 may receive a query that may be indicative of a set of time-series computation functions. The set of time-series computation functions are to be executed in a graph (e.g., the directed property graph 110). The graph includes various message nodes and attribute nodes, with each message node representing a message, having some attributes of the message associated as node properties thereof, and being associated with attribute nodes that represent shared attributes of the message.

At 1104, the processing circuitry 104 may identify, based on the query, one or more attribute nodes. The one or more attribute nodes may be identified in the graph. At 1106, the processing circuitry 104 may determine, based on the one or more attribute nodes, a set of message nodes. The set of message nodes may be determined in different ways described above in FIGS. 6-8. At 1108, the processing circuitry 104 may identify, from node properties of each message node of the set of message nodes, one or more attributes required for execution of the set of time-series computation functions. Each identified attribute of the one or more attributes corresponds to a message timestamp. At 1110, the processing circuitry 104 may execute the set of time-series computation functions based on the identified one or more attributes of each message node of the set of message nodes. At 1112, the processing circuitry 104 may generate an analytics outcome based on the execution of the set of time-series computation functions.

The disclosed embodiments encompass numerous advantages including an efficient and seamless approach for facilitation of time-series message management using the directed property graph 110. The structure of the directed property graph 110 allows efficient query processing as designing the shared attributes as the attribute nodes aids in faster identification of correlated one or more message nodes that are required for the execution of the query. Further, the association of other attributes as node properties prevents unnecessary database lookups as well as allows efficient memory utilization. Relationships between one or more messages may be further analyzed based on the edge properties associated with each edge that allow low-latency traversal to the relevant message nodes for query processing.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for time-series message management using directed property graphs. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. A system, comprising:
   a storage element configured to store a graph that comprises a plurality of message nodes and a plurality of attribute nodes, wherein each message node of the plurality of message nodes:
      represents a message,
      has a first set of attributes of the message associated as node properties thereof, and
      is associated with a set of attribute nodes, of the plurality of attribute nodes, that represents a second set of attributes of the message; and
   processing circuitry that is coupled to the storage element, and configured to:
      receive a query that is indicative of a set of time-series computation functions to be executed in the graph;
      identify, based on the query, one or more attribute nodes from the plurality of attribute nodes;
      determine, based on the one or more attribute nodes, a set of message nodes of the plurality of message nodes;
      identify, from the node properties of each of the set of message nodes, one or more attributes required for execution of the set of time-series computation functions, wherein each of the one or more attributes corresponds to a message timestamp; and
      execute the set of time-series computation functions based on the identified one or more attributes of each of the set of message nodes.
2. The system of 1, wherein each message timestamp identified from each message node of the set of message nodes is indicative of a milestone associated with the message represented by the corresponding message node.
3. The system of 2, wherein the milestone corresponds to one of a group consisting of a creation event, a raise event, a subscription event, a handle event, or a process event.
4. The system of 1, wherein each message timestamp identified from each message node of the set of message nodes corresponds to one of a group consisting of a created-on timestamp, a raised-on timestamp, a received-on timestamp, a handled-on timestamp, or a processed-on timestamp associated with the message represented by the corresponding message node.
5. The system of 1, wherein the set of time-series computation functions includes one or more mathematical computations that, when executed on the identified one or more attributes of each of the set of message nodes, generate a set of computation outputs indicative of system performance, and wherein the processing circuitry is further configured to generate an analytics outcome by executing one or more database operations on the set of computation outputs.
6. The system of 5, wherein the one or more database operations comprise at least one of a group consisting of an intersection operation or a union operation.
7. The system of 5, wherein each time-series computation function of the set of time-series computation functions includes one or more parameters, where one or more parameter values of the one or more parameters, respectively, are derived from the identified one or more attributes of each of the set of message nodes, and wherein the processing circuitry executes each time-series computation function based on the derived one or more parameter values.
8. The system of 7, wherein the processing circuitry is further configured to define the one or more parameters of each time-series computation function of the set of time-series computation functions based on one of a group consisting of one or more message milestones or a user input.
9. The system of 1, wherein the message has a plurality of attributes associated therewith, and wherein the plurality of attributes comprises at least two of a group consisting of an identifier, a correlation identifier, a user identifier, a name, a category, a topic, a key, a scope, an access, a status, an execution, an action, a message type, a created-on timestamp, a raised-on timestamp, a received-on timestamp, a handled-on timestamp, a processed-on timestamp, a publisher identifier, a subscriber identifier, an allow retry, a maximum retry allowed, a retry count, a retry source identifier, a source identifier, or a source type.
10. The system of 1, wherein the first set of attributes comprises at least one of a group consisting of an identifier, a name, a category, a topic, a key, a scope, an access, a status, an execution, an action, a message type, a created-on timestamp, a raised-on timestamp, a received-on timestamp, a handled-on timestamp, a processed-on timestamp, a publisher identifier, a subscriber identifier, an allow retry, a maximum retry allowed, a retry count, a retry source identifier, a source identifier, or a source type.
11. The system of 1, wherein each of the second set of attributes is shared with at least one other message.
12. The system of 1, wherein the second set of attributes comprises at least one of a group consisting of an identifier, a correlation identifier, a user identifier, a created-on timestamp, a raised-on timestamp, a received-on timestamp, a handled-on timestamp, or a processed-on timestamp.
13. The system of 1, wherein for each attribute node of the plurality of attribute nodes, a third set of attributes is associated as node properties thereof, wherein the third set of attributes is linked with an attribute represented by the corresponding attribute node, and wherein the processing circuitry determines the set of message nodes further based on the node properties of each of the one or more attribute nodes.
14. The system of 1, wherein at least a first attribute node of the one or more attribute nodes is associated with a first message node and a second message node, of the set of message nodes, and wherein the processing circuitry determines the first message node and the second message node based on the first attribute node.
15. The system of 1, wherein the graph further comprises a first plurality of edges, with a set of edges coupling each message node, of the plurality of message nodes, to the corresponding set of attribute nodes, wherein each edge, of the set of edges, has a set of edge attributes associated as edge properties thereof, the set of edge attributes being indicative of an association between the corresponding message node and a corresponding attribute node, and wherein the processing circuitry determines at least a first message node of the set of message nodes based on at least one of (i) one or more edges, of the first plurality of edges, coupling the one or more attribute nodes to the first message node, respectively, or (ii) the edge properties of each of the one or more edges.
16. The system of 15, wherein the edge properties of each edge of the set of edges comprise (i) at least one attribute associated as the node properties of the corresponding message node, and (ii) at least one attribute associated as node properties of the corresponding attribute node.
17. The system of 15, wherein the graph further comprises a second plurality of edges, with each edge coupling two message nodes of the plurality of message nodes, wherein each edge coupling two message nodes has another set of edge attributes associated as edge properties thereof, the other set of edge attributes being indicative of a causal association between the two message nodes, and wherein after determining the first message node of the set of message nodes, the processing circuitry is further configured to identify an edge coupling the first message node to a second message node, of the set of message nodes, and determine the second message node based on the edge properties of the identified edge.
18. The system of 17, wherein a second message represented by the second message node is generated based on a processing of a first message represented by the first message node.
19. The system of 15, wherein the graph further comprises a third plurality of edges, with each edge coupling two attribute nodes of the plurality of attribute nodes, wherein each edge coupling two attribute nodes has another set of edge attributes associated as edge properties thereof, the other set of edge attributes being indicative of an association between the two attribute nodes, wherein the processing circuitry is further configured to identify an edge, of the third plurality of edges, coupling at least one attribute node of the one or more attribute nodes to another attribute node, of the plurality of attribute nodes, and identify the other attribute node based on the identified edge, and wherein the processing circuitry determines a third message node of the set of message nodes based on the identified attribute node.
20. The system of 19, wherein the edge properties of the identified edge comprise (i) at least one attribute associated as node properties of the at least one attribute node, and (ii) at least one attribute associated as node properties of the other attribute node.
21. The system of 15,
   wherein the processing circuitry is further configured to generate the graph based on a plurality of messages and store the graph in the storage element, and
   wherein to generate the graph, the processing circuitry is further configured to instantiate a message node, of the plurality of message nodes, for each message of the plurality of messages, each message having a plurality of attributes, associate the first set of attributes of the plurality of attributes of each message as the node properties of the instantiated message node, derive, from the plurality of attributes of each message, the second set of attributes that is shared with at least one other message of the plurality of messages, instantiate the set of attribute nodes that represents the second set of attributes, create the set of edges, of the first plurality of edges, between each message node and the set of attribute nodes, determine, for each edge of the set of edges, from the plurality of attributes, the set of edge attributes, and associate the set of edge attributes as the edge properties of each edge of the set of edges.
22. The system of 21, wherein to generate the graph, the processing circuitry is further configured to create an edge between two instantiated message nodes, determine, based on the plurality of attributes of each message represented by the two instantiated message nodes, another set of edge attributes, and associate the other set of edge attributes as the edge properties of the edge created between the two instantiated message nodes.
23. The system of 1, wherein the graph corresponds to a directed property graph.
24. The system of 1, wherein each message corresponds to at least one of a group consisting of a command message, a query message, or an event message.
25. A method, comprising:
   receiving, by processing circuitry, a query that is indicative of a set of time-series computation functions to be executed in a graph, wherein the graph comprises a plurality of message nodes and a plurality of attribute nodes, with each message node of the plurality of message nodes (i) representing a message, (ii) having a first set of attributes of the message associated as node properties thereof, and (iii) being associated with a set of attribute nodes, of the plurality of attribute nodes, that represents a second set of attributes of the message;
   identifying, by the processing circuitry, based on the query, one or more attribute nodes from the plurality of attribute nodes;
   determining, by the processing circuitry, based on the one or more attribute nodes, a set of message nodes of the plurality of message nodes;
   identifying, by the processing circuitry, from the node properties of each of the set of message nodes, one or more attributes required for execution of the set of time-series computation functions, wherein each of the one or more attributes corresponds to a message timestamp; and
   executing, by the processing circuitry, the set of time-series computation functions based on the identified one or more attributes of each of the set of message nodes.

What is claimed is:

1. A system, comprising:
a storage element configured to store a graph that comprises a plurality of message nodes and a plurality of attribute nodes, wherein each message node of the plurality of message nodes:
represents a message,
has a first set of attributes of the message associated as node properties thereof, and
is associated with a set of attribute nodes, of the plurality of attribute nodes, that represents a second set of attributes of the message; and
processing circuitry that is coupled to the storage element, and configured to:
receive a query that is indicative of a set of time-series computation functions to be executed in the graph;
identify, based on the query, one or more attribute nodes from the plurality of attribute nodes;
determine, based on the one or more attribute nodes, a set of message nodes of the plurality of message nodes;
identify, from the node properties of each of the set of message nodes, one or more attributes required for execution of the set of time-series computation functions, wherein each of the one or more attributes corresponds to a message timestamp; and
execute the set of time-series computation functions based on the identified one or more attributes of each of the set of message nodes.

2. The system of claim 1, wherein each message timestamp identified from each message node of the set of message nodes is indicative of a milestone associated with the message represented by the corresponding message node.

3. The system of claim 2, wherein the milestone corresponds to one of a group consisting of a creation event, a raise event, a subscription event, a handle event, and a process event.

4. The system of claim 1, wherein each message timestamp identified from each message node of the set of message nodes corresponds to one of a group consisting of a created-on timestamp, a raised-on timestamp, a received-on timestamp, a handled-on timestamp, or a processed-on timestamp associated with the message represented by the corresponding message node.

5. The system of claim 1,
wherein the set of time-series computation functions includes one or more mathematical computations that, when executed on the identified one or more attributes of each of the set of message nodes, generate a set of computation outputs indicative of system performance, and
wherein the processing circuitry is further configured to generate an analytics outcome by executing one or more database operations on the set of computation outputs.

6. The system of claim 5, wherein the one or more database operations comprise at least one of a group consisting of an intersection operation or a union operation.

7. The system of claim 1,
wherein each time-series computation function of the set of time-series computation functions includes one or more parameters, where one or more parameter values of the one or more parameters, respectively, are derived from the identified one or more attributes of each of the set of message nodes, and
wherein the processing circuitry executes each time-series computation function based on the derived one or more parameter values.

8. The system of claim 7, wherein the processing circuitry is further configured to define the one or more parameters of each time-series computation function of the set of time-series computation functions based on one of a group consisting of one or more message milestones or a user input.

9. The system of claim 1, wherein the first set of attributes comprises at least one of a group consisting of an identifier, a name, a category, a topic, a key, a scope, an access, a status, an execution, an action, a message type, a created-on timestamp, a raised-on timestamp, a received-on timestamp, a handled-on timestamp, a processed-on timestamp, a publisher identifier, a subscriber identifier, an allow retry, a maximum retry allowed, a retry count, a retry source identifier, a source identifier, or a source type.

10. The system of claim 1, wherein each of the second set of attributes is shared with at least one other message.

11. The system of claim 1, wherein the second set of attributes comprises at least one of a group consisting of an identifier, a correlation identifier, a user identifier, a created-on timestamp, a raised-on timestamp, a received-on timestamp, a handled-on timestamp, or a processed-on timestamp.

12. The system of claim 1,
wherein for each attribute node of the plurality of attribute nodes, a third set of attributes is associated as node properties thereof,
wherein the third set of attributes is linked with an attribute represented by the corresponding attribute node, and
wherein the processing circuitry determines the set of message nodes further based on the node properties of each of the one or more attribute nodes.

13. The system of claim 1, wherein at least a first attribute node of the one or more attribute nodes is associated with a first message node and a second message node, of the set of message nodes, and wherein the processing circuitry determines the first message node and the second message node based on the first attribute node.

14. The system of claim 1,
wherein the graph further comprises a first plurality of edges, with a set of edges coupling each message node, of the plurality of message nodes, to the corresponding set of attribute nodes,
wherein each edge, of the set of edges, has a set of edge attributes associated as edge properties thereof, the set of edge attributes being indicative of an association between the corresponding message node and a corresponding attribute node, and
wherein the processing circuitry determines at least a first message node of the set of message nodes based on at least one of (i) one or more edges, of the first plurality of edges, coupling the one or more attribute nodes to the first message node, respectively, or (ii) the edge properties of each of the one or more edges.

15. The system of claim 14,
wherein the graph further comprises a second plurality of edges, with each edge coupling two message nodes of the plurality of message nodes, and having another set of edge attributes associated as edge properties thereof,
wherein the other set of edge attributes is indicative of a causal association between the two message nodes, and
wherein after determining the first message node of the set of message nodes, the processing circuitry is further configured to identify an edge coupling the first message node to a second message node, of the set of message nodes, and determine the second message node based on the edge properties of the identified edge.

16. The system of claim 15, wherein a second message represented by the second message node is generated based on a processing of a first message represented by the first message node.

17. The system of claim 14,
wherein the graph further comprises a third plurality of edges, with each edge coupling two attribute nodes of the plurality of attribute nodes, and having another set of edge attributes associated as edge properties thereof,
wherein the other set of edge attributes is indicative of an association between the two attribute nodes,
wherein the processing circuitry is further configured to identify an edge, of the third plurality of edges, coupling at least one attribute node of the one or more attribute nodes to another attribute node, of the plurality of attribute nodes, and identify the other attribute node based on the identified edge, and
wherein the processing circuitry determines a third message node of the set of message nodes based on the identified attribute node.

18. The system of claim 14,
wherein the processing circuitry is further configured to generate the graph based on a plurality of messages and store the graph in the storage element, and
wherein to generate the graph, the processing circuitry is further configured to:
instantiate a message node, of the plurality of message nodes, for each message of the plurality of messages, each message having a plurality of attributes;
associate the first set of attributes of the plurality of attributes of each message as the node properties of the instantiated message node;
derive, from the plurality of attributes of each message, the second set of attributes that is shared with at least one other message of the plurality of messages;
instantiate the set of attribute nodes that represents the second set of attributes;
create the set of edges, of the first plurality of edges, between each message node and the set of attribute nodes;
determine, for each edge of the set of edges, from the plurality of attributes, the set of edge attributes; and
associate the set of edge attributes as the edge properties of each edge of the set of edges.

19. The system of claim 18, wherein to generate the graph, the processing circuitry is further configured to:
create an edge between two instantiated message nodes;
determine, based on the plurality of attributes of each message represented by the two instantiated message nodes, another set of edge attributes; and
associate the other set of edge attributes as the edge properties of the edge created between the two instantiated message nodes.

20. A method, comprising:
receiving, by processing circuitry, a query that is indicative of a set of time-series computation functions to be executed in a graph, wherein the graph comprises a plurality of message nodes and a plurality of attribute nodes, with each message node of the plurality of message nodes:
representing a message,
having a first set of attributes of the message associated as node properties thereof, and
being associated with a set of attribute nodes, of the plurality of attribute nodes, that represents a second set of attributes of the message;
identifying, by the processing circuitry, based on the query, one or more attribute nodes from the plurality of attribute nodes;
determining, by the processing circuitry, based on the one or more attribute nodes, a set of message nodes of the plurality of message nodes;
identifying, by the processing circuitry, from the node properties of each of the set of message nodes, one or more attributes required for execution of the set of time-series computation functions, wherein each of the one or more attributes corresponds to a message timestamp; and
executing, by the processing circuitry, the set of time-series computation functions based on the identified one or more attributes of each of the set of message nodes.
